(19) United States
(12) Patent Application Publication
(10) Pub. No.: US 2014/0025390 A1
(43) Pub. Date: Jan. 23, 2014

(54) Apparatus and Method for Automated Outcome-Based Process and Reference Improvement in Healthcare

(71) Applicant: Michael Y. Shen, Fort Lauderdale, FL (US)

(72) Inventor: Michael Y. Shen, Fort Lauderdale, FL (US)

(21) Appl. No.: 13/555,127

(22) Filed: Jul. 21, 2012

(51) Int. Cl. G06Q 50/22

(52) U.S. Cl. 705/2

(57) ABSTRACT

A computer implemented system is provided for improving healthcare performance through use of outcome, reference and process modules. The interactions of these 3 modules impact a variety of aspects of healthcare service (e.g., diagnosis, treatment, clinical, management, finance, fraud and waste, etc.) and can build a functional eco system for healthcare service self improvement. This system is particularly useful to healthcare providers, payors (i.e., insurance companies), and healthcare compliance organizations (e.g., federal and state governments).

This invention relates to the field of healthcare systems for performance measurement and management improvement. More particularly, the invention relates to a unique system and method to evaluate, manage and optimize a patient care process and associated healthcare service business process using standard references, outcomes and the interactions among process, reference and outcome component structures in healthcare industry.

### I. BACKGROUND OF THE INVENTION

Continuously measuring, monitoring and optimizing performance in business process using automated tools in information technology (IT) is central to healthcare industry. Over the many decades, developments of process reengineering and measurement tools have been used to address these challenges. To achieve these goals objectively and quantitatively, customization of process engineering to fit a variety business processes has fundamentally changed society through industrial revolution. Over the last a few decades, creation and customization of industrial guidelines have provided standards as References for performance measurement of its Process. The Process and related Reference set forth the foundation of IT software developments in this area. However, current healthcare systems have not systematically deployed related industrial standards as measurements to its designated business process. Further, the real world results have not been systematically linked for any given business decision to check its final outcomes to improve its process and reference in a real time and automated manner.

Developments in evidence-based medicine over the last two decades have shown that outcomes are the true center and the final judgment of the performance for any decision from any business process and measurement from any standards.

With regard to outcomes, current healthcare IT systems based on process and standards have a number of limitations. One such limitation is that there is no systematic follow-up to collect data on process outcomes to track the performance of the process in a real time and automated manner. For example, radiologists receive no systematic follow-up for their radiology reports. When a radiologist reports a mass on a CT scan of a patient as diagnosis of lung cancer based on his experience, the accuracy of his diagnosis on this kind of patient is not confirmed until biopathy or pathology after surgery. There is presently no organized system to automatically inform the radiologist of the confirmation information relating to the radiologist's diagnosis. Due to the fact that healthcare delivery processes are administrative and technologically based, those processes lack continuity of care and do not adequately assess the effectiveness of care and of outcomes.

Another limitation of current healthcare IT systems is that they do not track and compare short term outcomes with long term outcomes. A majority of business decision judgments in healthcare are often based on good short-term outcomes without consideration of the long-term outcomes which may be detrimental. For example, the CAST study (Cardiac Arrhythmia Suppression Trial) has fundamentally changed Flecainide, the standard treatment, physicians used for patients with arrhythmia in 1980s. The Trial actually showed more patients taking the medication long term died than those not taking the medication at all. Accordingly, despite the fact that the medication can decrease the frequency of arrhythmia in the short term, that comes at a price of possible fatality in the long term. It is critical to continuously track both short-term and long-term outcomes of important decisions for any business process and make appropriate adjustments if the short and long term outcomes do not fit the original business goals or industrial standard measures.

Still another limitation of current healthcare IT systems is that they do not provide analysis of outcomes related with business processes and standards. The present inventors are not aware of any systems designated to track, measure and improve a business process performance in a variety of aspects of the outcomes systematically in an automated fashion, such as diagnosis of diseases (diagnostic outcomes), prediction of the impact (prognostic outcomes), treatment selection to cure the diseases (treatment outcomes), healthcare service performance (service outcome), communications with patients and business associates (communication outcome), patient attitude and happiness (satisfaction/mentality Outcomes), performance in the steps and whole healthcare process (workflow outcomes), performance in accessing/utilizing information in the steps and whole healthcare process (information flow outcomes), efficiency and effectiveness of management and planning (management outcomes) and cost and benefits (financial outcomes), etc.

Yet a further limitation of current IT healthcare systems is that they provide no effective and flexible formats for enhancing communication outcomes, since current EMR systems and their related performance analytics systems focus more on the process or performance compared to standard/references for later use, not the interaction among the Process, Reference and Outcomes to understand and proceed based on guidelines as well as subsequent outcomes related to the care. For example, a typical radiologist report describes the imaging findings entirely in text format. Such a format is limited in communicating relevant information. It is often necessary to sit down with a radiologist to see the scan and to listen to the interpretation to get voice, image along with text based reports. There is no reliable means to measure and track the level of understanding of the outcomes from referral physicians or patients.

Industrial standards, healthcare guidelines or even specific organizational goals are the basic references to assess business process performance. However, the inventors are aware of no healthcare system that systematically and automatically measures, tracks and improves the performance of these references for comparison. For example, studies have suggested that only 30% of indications (standard content) from national practice guidelines are evidence-based with thorough validations through outcomes.

Still a further limitation of current healthcare IT systems is that they provide no analysis of the outcomes to learn patterns and evaluation. For example, after tracking a person with medical records, the physician can link all related symptoms with his occurrences of diseases to learn his patterns, and potentially to identify many of those symptoms. Later on, when those symptoms occur again, possible treatments may be taken to avoid the diseases.

### II. SUMMARY OF THE INVENTION

The present invention is directed to an automated, real time healthcare performance system for improving patient care processes employing process, reference and outcome modules. The system includes a plurality of sub-processes and each sub-process includes a plurality of steps. In one embodiment, the system includes a first computer that receives patient care process data from one of a service provider, a payor, and a patient. The system further includes a process module operating on a server in communication with the first computer that (1) generates a model of the patient care process, (2) maps said plurality of sub-processes and said plurality of steps to the patient care process, (3) receives data generated in the patient care process, (4) stores that data in accordance with the map and model, links the data to reference and outcome modules. A reference module receives references and extracts and converts the references to computer usable format. An outcome module is connected to the process module and the reference module, and said outcome module identifies a specific outcome for analysis based on user input, receives patient care process data corresponding to the specific outcome, analyzes patient care process data based on a user defined model/calculation and generates outcome data indicative of performance of the patient care process.

### III. BRIEF DESCRIPTION OF THE DRAWINGS

FIG. 1 illustrates a system diagram in accordance with the present invention.

FIG. 2 depicts a hardware diagram of the functional modules of the present invention.

FIG. 3A shows the creation of a patient care decision-making process in accordance with the invention.

FIG. 3B shows an example of the patient care decision-making process in the FIG. 3A as applied to patients with diabetes.

FIG. 4 depicts the mapping of healthcare processes with corresponding sub-processes and steps in different levels in accordance with the invention.

FIG. 5 illustrates the link between process and references with an Index system in accordance with the invention.

FIG. 6 shows the link between outcome and processes with an Index system in accordance with the invention.

FIG. 7 depicts process creation with an example in healthcare service process in accordance with the invention.

FIG. 8 illustrates a method of setting up outcome in accordance with the invention.

FIG. 9 shows a database schema used for outcome evaluation in accordance with the invention.

FIG. 10-1A illustrates a first set of parameters for a first set of healthcare outcomes in accordance with the invention.

FIG. 10-1B shows a second set of parameters for the first set of healthcare outcomes in accordance with the invention

FIG. 10-2A shows a first set of parameters for a second set of healthcare outcomes in accordance with the invention.

FIG. 10-2B illustrates a second set of parameters for a second set of healthcare outcomes in accordance with the invention

FIG. 10-3A, 10-3B, 10-4A, 10-4B—show the examples for corresponding FIGS. of 10-1A,10-1B, 10-2A and 10-2B respectively using assessment of diabetes as a clinical scenario.

FIG. 11-22 show outcome evaluation GUIs for healthcare services in accordance with the invention.

FIGS. 23A-23C illustrates automated and real time diagnostic outcome reports.

FIG. 24 depicts an automated and real time service outcome report.

### IV. DETAILED DESCRIPTION OF THE DRAWINGS

### Functionality Overview

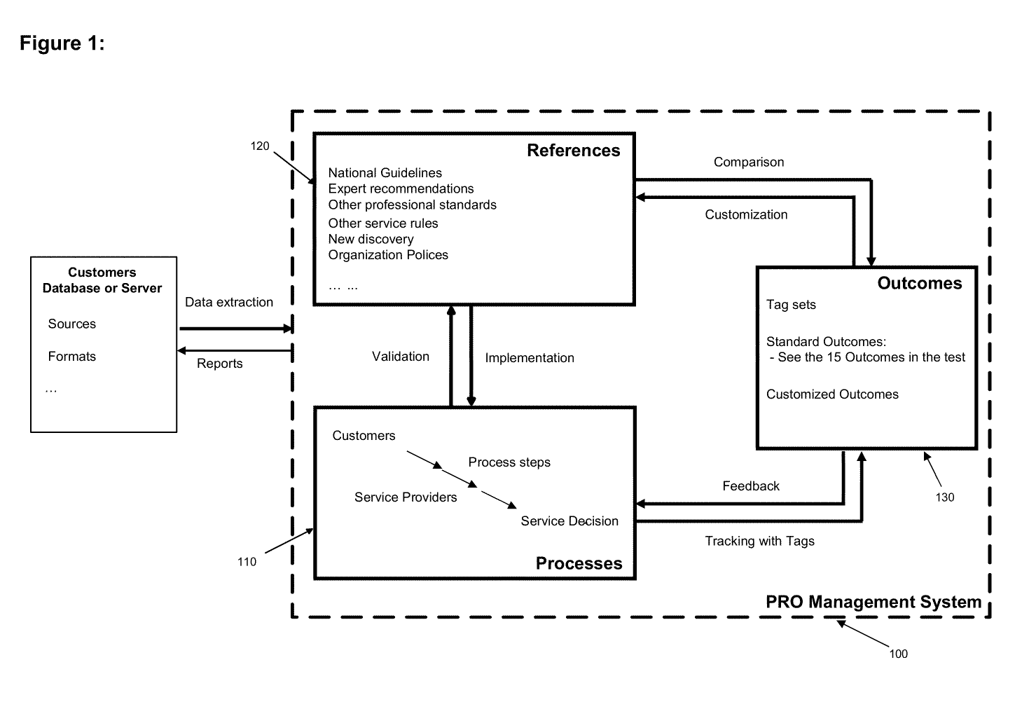

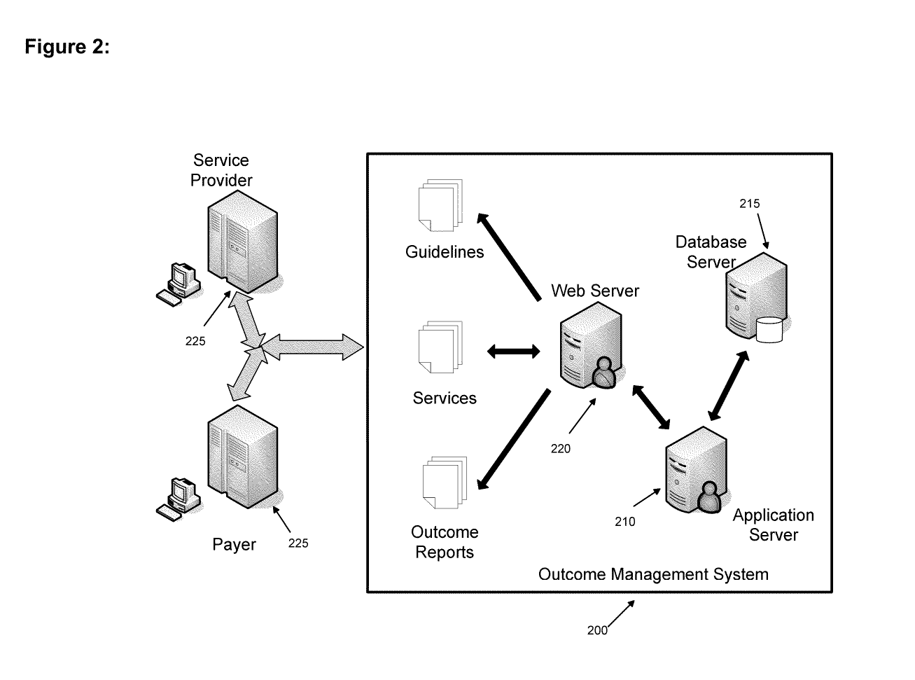

The present invention is embodied in an automated real time healthcare management system referred to herein as the PRO (Process, Reference and Outcome) system. FIG. 1 illustrates an exemplary system 100 that may be realized by one or more functional modules. Process module 110 tracks the patient care process as performed by one or more healthcare service providers. As used herein, healthcare service providers refer to entities or individuals that perform patient care processes in healthcare industry. Exemplary process providers include healthcare providers such as hospitals, clinics, medical doctors, registered nurses, laboratories and imaging centers.

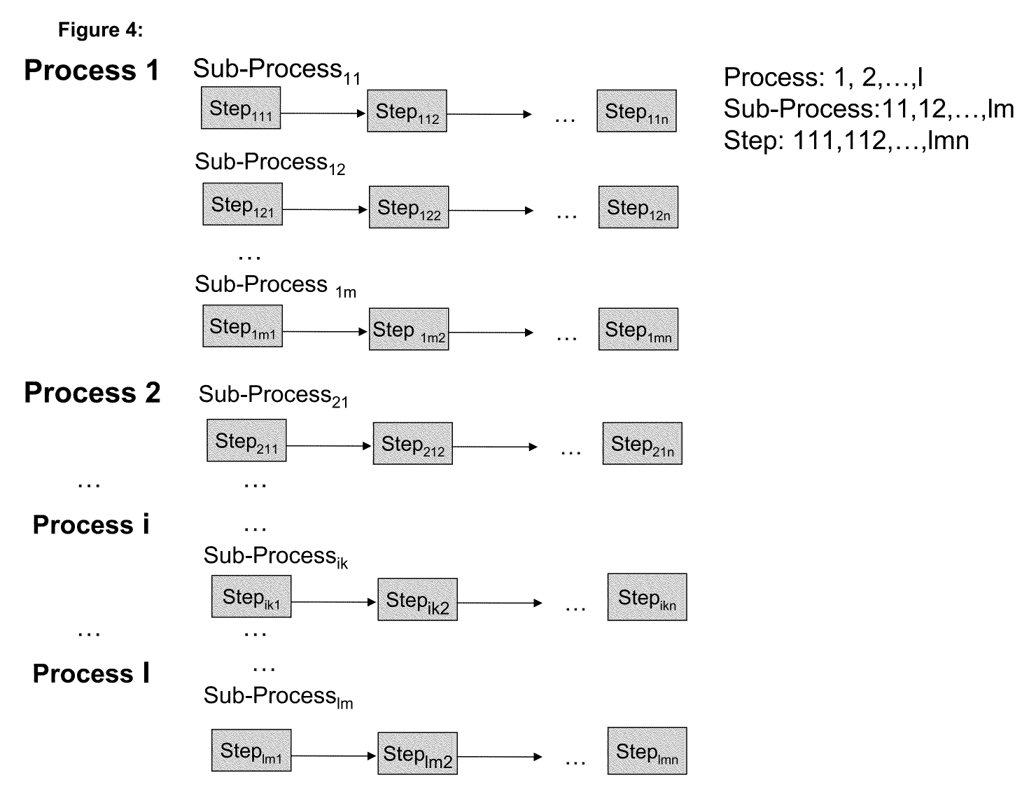

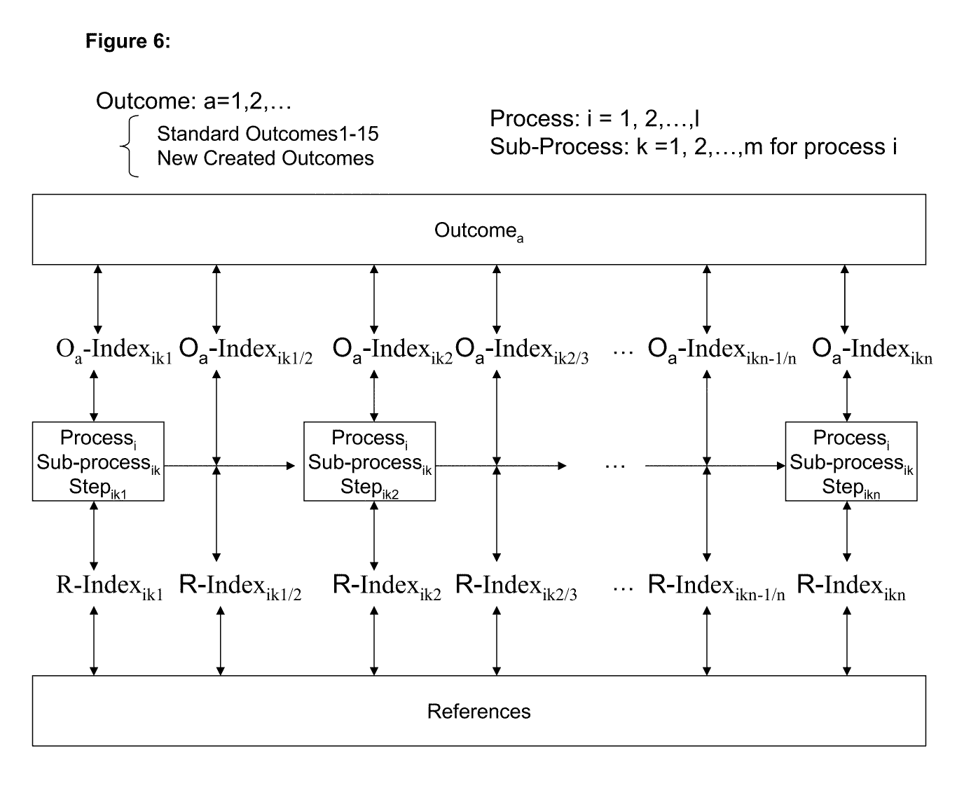

Process module 110 models the patient care process and maps the process to a plurality of sub-processes and steps which correspond to the sub-processes. Process module 110 also receives data generated in the patient care process and stores that data according to the patient care process model. The steps, sub-processes and processes create a basic matrix and foundation for an Index system to link to its related References and Outcomes (see FIG. 4-6).

Reference module 120 stores references for each healthcare process step such as industrial standards, national guidelines, other professional standards, expert recommendations, service rules, new study findings and discoveries, or organizational goals/policies. These references in the Module 120 link to the steps/sub-processes/processes in the Process Module 110 using an Index system. Reference module 120 also analyzes one or more sub-processes or steps of the patient care process in comparison with the references to generate patient care process performance indicators. Reference module 120 also facilitates modification of references based on feedback from outcome module 130 and facilitates creation of new references for the improvement of patient specific care processes.

Outcome module 130 provides a plurality of standard outcome measurements in healthcare and it allows the user to define its own outcome measurements. In accordance with an aspect of the invention, Outcome module 130 automatically collects, through a Tag System, tags and tracks patient care process data from Process module 110, as well as collects, through the Tag System, tags and tracks reference data from Reference module. Thus, Outcome module 130 analyzes the patient care process data and the reference data based on user defined models or calculations and generates outcome data, indicative of performance of the patient care process, and of performance of its reference respectively. Outcome module 130 transmits outcome data to designated report site based on user defined means and schedules.

### Hardware/Software System Overview

A PRO outcome management system according to the invention is shown in general block-diagram form in FIG. 2.

The PRO outcome management system 200 generally comprises a standard client-server architecture including an application server 210, a database server 215, web or network server 220 and one or more service provider and/or payor computers/servers 225. Application server 210 operates a suite of functional modules including process module 110, outcome module 130 and reference module 120. In one embodiment, service provider/payor computers are connected to application server 210, database server 215 and web server 220 via the Internet. However, these computers may be connected in any available network architecture.

Application server 210, database server 215 and web server 220 may be resident on a single computer or may be distributed between multiple computers. Web server 220 provides a convenient way for authorized users to access system 200. Using web browsers, users may browse healthcare guidelines, patient's medical records, and healthcare outcome reports. Web server 220 generates graphic user interfaces which enable various kinds of web services for end users (doctors, directors, etc). Using the servers (210, 215 and 220), the detailed Process Module, Reference Module and Outcome Module will be created. An interface system is used to link the servers to map the data sources for data transfer.

Web server 220 may be implemented on various computer platforms. Windows® platforms and Linux® platforms are suitable. For Windows, many versions of operating systems can be used, such as Windows XP Server, Windows 2003 Server and the like. For Linux, Redhat v.9 and later are suitable operating systems. Suitable web server software includes Apache servers and Tomcat servers. In a preferred embodiment, web server 220 is implemented using Windows Server 2003 with service pack 2 and Apache HTTP Server 2.2.4.

Database server 215 stores all system data. In some embodiments, multiple database servers may be used for data replication and to increase the availability of system resources. Suitable database servers include Microsoft SQL Server version 2003 and forward and Oracle Database Server: version 9 and forward. In some embodiments, the data base server 215 is used for all functional databases of the system.

Application server 210 creates a middle layer between web server 220 and database server 215. Users submit their requests to web server 220 which passes those requests to application server 210. Application server 210 verifies and analyzes those requests and retrieves data from database server 215 when needed. Application server 210 implements business rules, logic and algorithms. For example, using patient care process data and references, application server 210 can evaluate patient care process performance and outcome reports.

Application server 210 may be implemented on a variety of computer platforms. Suitable operating systems include Windows operating systems such as Windows XP Server and Windows 2003 Server and Linux operating systems such as Redhat v.9 and forward. Suitable code compiling software such as PHP, Java, .Net and others.

An exemplary embodiment of the invention will be described in connection with a patient care selection process to describe its reference and outcome creation and use. However, the skilled artisan will realize that the invention may be readily modified to manage any healthcare process.

### Process Module

The process module 110 (FIG. 1) includes a multiple-tier structured matrix, as illustrated in FIG. 4: multiple steps form a sub-process, and multiple sub-processes form a process. Multiple processes are ordered from basic ones to the top, usually used to describe functions of the entire healthcare service structure and delivery. The multiple processes can include an administrative hierarchy (such as hospital, county, state, country) or functional hierarchy. At the end, the matrix of the processes provides a map of structure with sequences and layers of sub-processes/steps. The hierarchy and relationship of the subprocesses and its steps provide functions for a patient care process.

As shown in FIG. 4-6, indexes are created based on the processes with corresponding subprocess and steps. The indexes are used to link related references and outcomes to the process matrix (FIG. 4) for performance assessment.

Patient Care Process:

A patient care process includes: (a). multiple sub-processes each having multiple steps, and (b). providers involved in the process. The process is also linked with the references (as a standard or guidelines) related with the steps of the process and the outcomes of the process. A process can be modeled using the system of this invention in accordance with the following procedure:

(1). Identify and define the sub-processes included in the process
(2). Identify and define each step of a sub-process
(3). identify and define the data resource or input source for each step
(4). identify and define people involved in each step
(5). identify and define related references for each step
(6). Identify and define the outcomes related with the process and sub-process

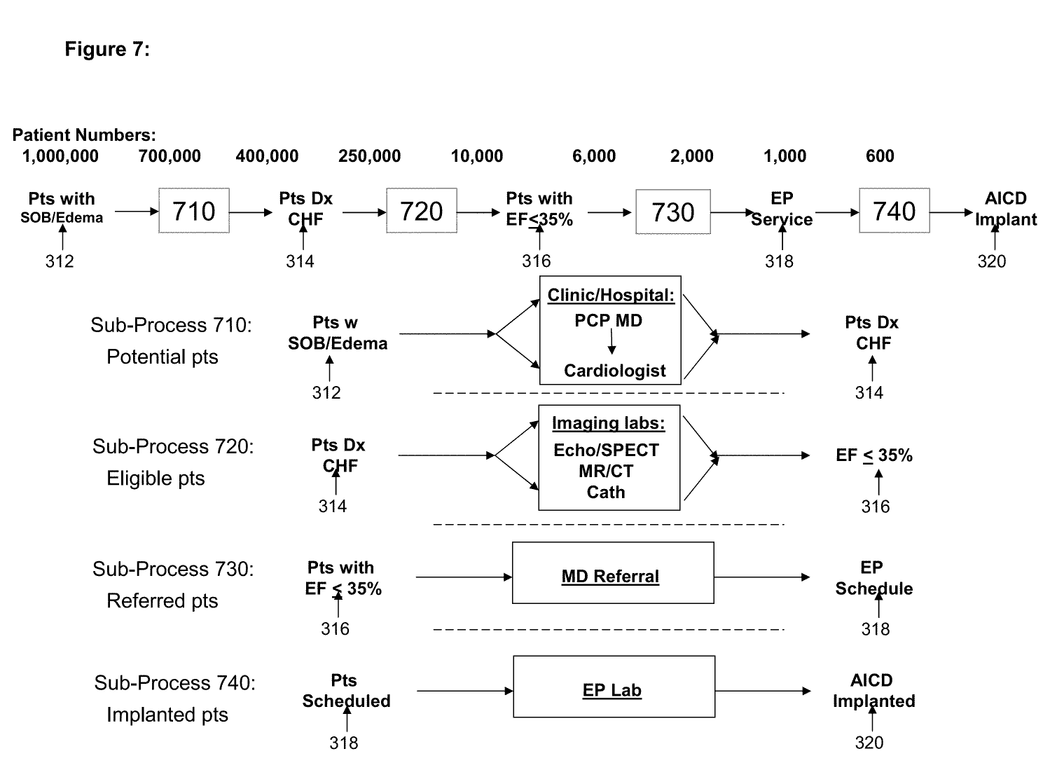

Process module 110 models a patient care process. For example, FIG. 7 illustrates a model for the process of AICD (automatic implantable cardiac defibrillator) use. The procedures of modeling include the following:

(1). Identify and define the sub-processes included in the process

In the example illustrated in FIG. 7, the sub-processes 710 is to identify potential patients for AICD; Sub-process 720 is to identify eligible patients for AICD; Sub-process 730 is to identify referred patients; Sub-process 740 is to identify implanted patients.

(2). Identify and define each step of a sub-process

As illustrated in FIG. 7, each sub-process includes multiple steps. For example sub-process 710 includes the steps of identifying patients with shortness of breath (SOB)/Edema, evaluation by primary care physician and cardiologist, and diagnosing patients with heart failure. Similarly, Sub-processes 720-740 include steps as illustrated and self-explained.

(3). Identify and define the data resource or input source for each step

The data sources for data needed to perform each step will be mapped from the related databases of a healthcare provider such as EMR or EHR (Electronic Medical Record, or Electronic Health Record). For example, data for step 312, 314 and 320 (FIG. 7) are mapped from the clinical notes portion of the EMR. Data for step 316 is mapped from the test reports of the EMR. Data for step 318 is mapped from the provider list portion of the EMR. Data for step 320 is mapped from either the clinical notes or the ICD9 list portion of the EMR. The mapping can be achieved using commercially available or newly designed systems.

(4). Identify and define players involved in each step

The provider responsible for performing the step is identified by identifying characteristics such as name, position, employer, etc.

(5). Identify and define related references for each step

The references by definition relate to various steps of the patient care process. All references that relate to a given step are identified and indexed to their corresponding steps, sub-processes and process as shown in FIG. 7. For example, AHA heart failure guidelines which recommended all patients with CHF need to have an imaging test to calculate EF (ejection fraction) are indexed to step 316.

(6). Identify and define the outcomes related with the process

Based on the purpose of the analysis as defined by the user, the user names and selects the related outcomes for the patient care process.

Process module 110 collects data from each step of the patient care process, maps the data and stores the data in one or more indexed databases to provide the overall function of the Process module as illustrated in FIG. 4.

### Reference Module

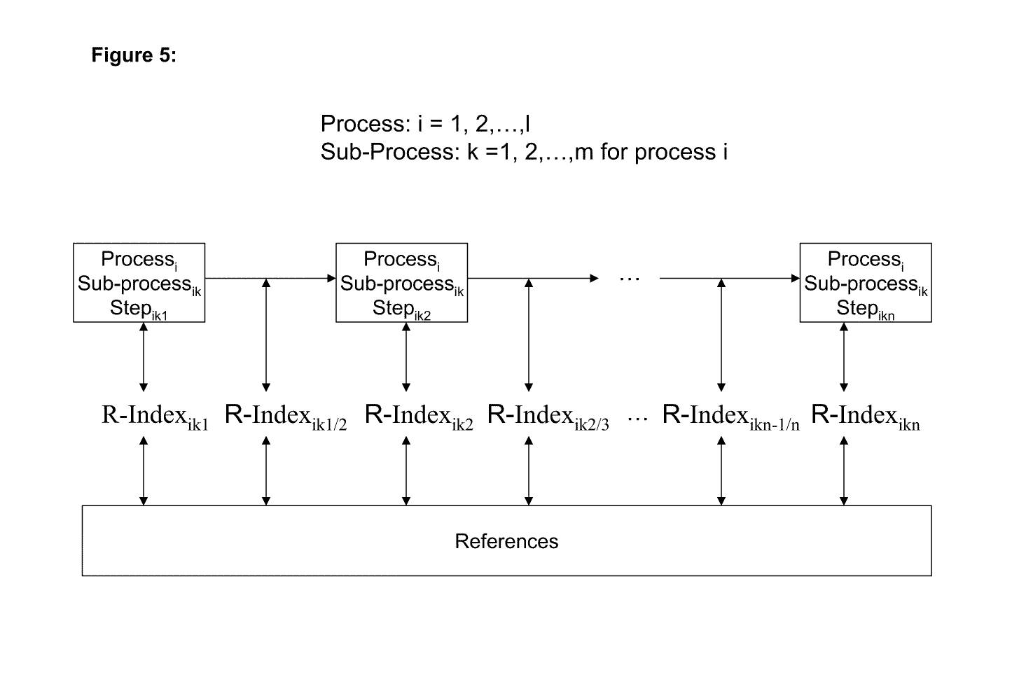

References are input to Reference module 120 (FIG. 1) from information sources and converted into digital format, indexed to the related processes, sub-processes and steps, and stored into a reference database, as shown in FIGS. 1 and 5.

Reference module 120 also analyzes one or more sub-processes or steps of the patient care process in comparison with the references to generate a patient care process performance indicator. More particularly, the indexed references are compared to related indexed, steps, sub-processes and processes to evaluate the performance of the care process. For example, the reference indexed to step 318 requires all patients with heart failure to have cardiac imaging tests for EF. In this example only 250,000 out of 400,000 patients were tested (62.5%) which demonstrates a 37.5% deviation from the standard, assuming 100% compliance to the standard.

### Outcome Module

Outcome module 130 (FIG. 1) provides systematic follow-up to patient care processes as various kinds of outcomes. A user can select or define its own outcomes and outcome module 130, then, tracks and analyzes those outcomes. In accordance with an embodiment of the invention, fifteen exemplary categories of healthcare outcomes are described. However, a user may define other new outcomes. Outcomes are the results and final judgment of the performance for both patient care selection Process and the References. There are many different outcomes in the healthcare field. Exemplary outcomes addressed herein include clinical outcomes, diagnostic outcomes, treatment outcomes, utilization outcomes, communication outcomes, service outcomes, management outcomes and financial outcomes, etc.

In accordance with the invention, web user interface is generated that prompts a user for information to setup outcomes for analysis. A user may setup and evaluate healthcare outcomes using the web user interface built in the system. For example, two diagnostic tests, cardiac CT and MRI, can be used to quantify LV Volume/LVEF (Left Ventricular Volume/Left Ventricular Ejection Fraction). These data have specific elements from specific data sources, test reports (Cardiac CTA Report and Cardiac MR Report). If one wishes to compare the CT results (to be tested) with MR (used as standard) to see the difference, MR results in the same patients can be used as outcome data for the purpose of comparison. Any data can potentially serve as outcome data for comparison based on the user's requirement and definition.

### Set Up Outcome Module

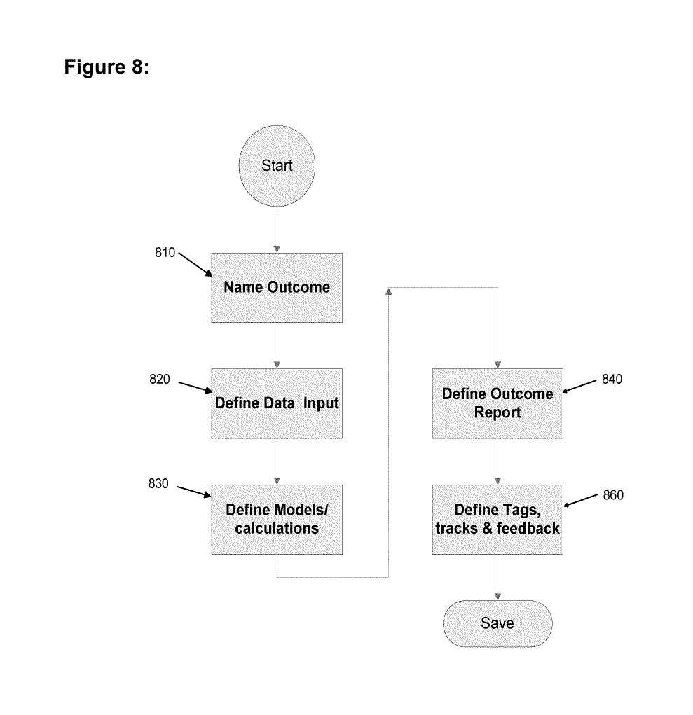

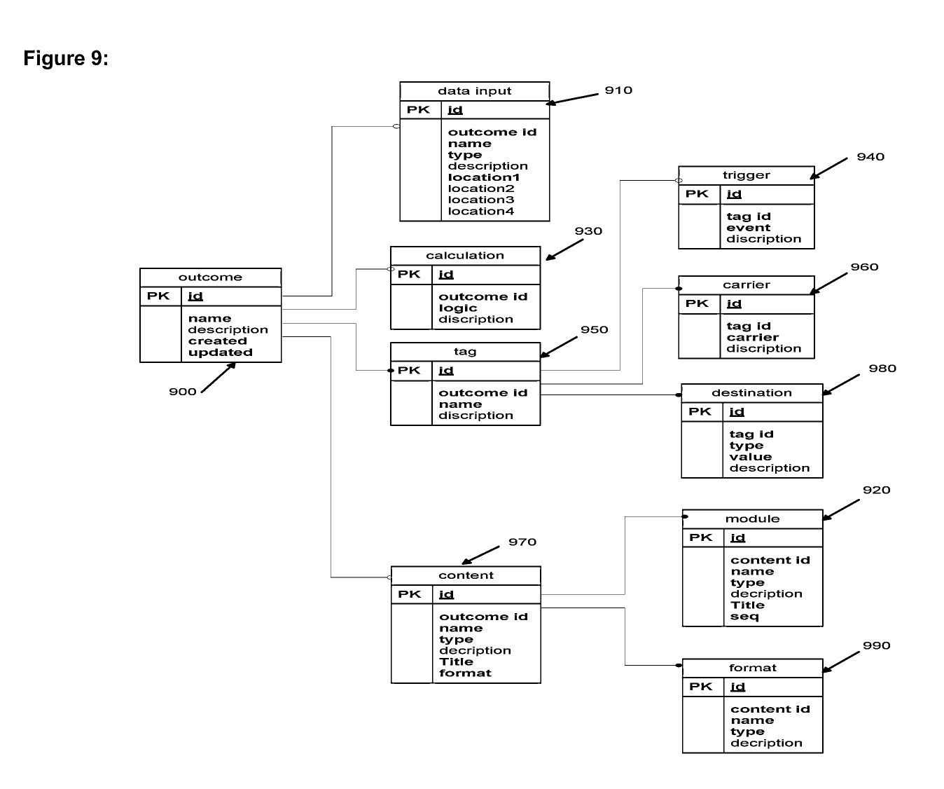

FIG. 8 illustrates the process of setting up an outcome module.

Step. 1: define the outcome

In step 810, the outcome name, category and the goal of the outcome are defined. A user inputs an outcome name with a selected category and key words for clarification. The goal of the outcome is to describe what the healthcare outcome analysis is designated for. For example, to assess the accuracy outcome of CT angiography for coronary disease, one can define the names as “Diagnostic Outcome of Coronary CTA; the Category is “Diagnostic Outcome” and the goal is to assess the sensitivity and specificity to diagnose coronary disease using CTA compared to catheterization as gold standard. Thus, the outcome is created and the data imported from multiple patients (usually from EMR) in outcome management system 100 and provider 225.

In addition, a healthcare outcome can also be defined as the integral of multiple other healthcare outcomes. For example, to evaluate a diagnostic SPECT imaging service, one can assess the balance between procedure volume and procedure quality/accuracy. Usually, there is a trade-off between volume and quality. When volume is too high, the quality may go down. To achieve the balance goal, many data need to be pulled together for comprehensive evaluation from diagnostic outcome (accuracy), management outcome (efficiency), service outcomes (volume) and financial outcome (cost and profit), etc. In accordance with the invention, a user may define one or multiple outcome subjects related to one healthcare process.

Step. 2: define data input

Step 820 defines data items used for evaluating outcomes and sources where, the data originated, as well as data formats. Data sources could be from specific servers, computers, database, folders, or files. The data formats define how the data is stored in database table, text in reports or messages (such as HL7 format). For example, to define Diagnostic Outcome of CTA, the data input needs to include individual patients with both CTA and cath diagnosis results for comparison and calculation of accuracy. When this outcome is defined and implemented in a hospital system, the related files from specific computers or servers are identified. The data is, then, automatically extracted for analysis after the mapping established.

The user specifies the location of the subject in the application system. The information is indexed and stored into a database table such as data input table 910 depicted in FIG. 9.

Step. 3: define outcome models and calculations

In step 830, the user defines how to analyze an outcome using an established/predefined, or new formulae/model with its related data input. Usually, a user can select standard, modified standard, or user defined formulae/model. For example, sensitivity and specificity are usually defined to calculate the Diagnostic Outcome. Different outcomes require different calculations. The user may specify the calculation logic. The data relating to outcome calculations are stored into a database table such as “Calculation” table 930 depicted in FIG. 9.

Step. 4: define outcome report

Step 840 defines outcome reports, including the content and the format. Outcome content provides detailed descriptions about the outcome. Through the report, a user will know the evaluation results and where the results come from. Every report contains a title and multiple sections. A section can be a part of the report or an attachment to the report. Sections may contain information including but not limited to:

1. Date/time when the report is generated

2. Data input

3. Evaluation results

4. Analytic models and/or calculations

5. Improvement recommendations

6. Original data resources as attachments

A user may choose various kinds of formats for outcome reports. The most common format is text format which is very close to human language. Charts and diagrams can also be included as part of outcome reports. Application systems may store original data resources in some multimedia formats, such as audio, still images, and video. The system according to the invention also provides tools that allow a user to select those multimedia data resources for inclusion in the outcome report. A user may select those data sources which will be linked to the outcome reports. The information about additional data resources is stored into a “content” table 970, a “module” table 920, and a “format” table 990 as shown in FIG. 9.

Step 5: define outcome tag sets and feedback.

As the final step of the outcome set up process step 860 is to links steps 1-4, specifies them how to function by a user, and automates the outcome analysis:
A subject outcome is named (1), input is defined (2), calculation or model is created (3), and output is defined (4). The tag sets will, then, link, specify and automate these 4 steps, making this module operating independently and automatically, defined by a user. Then, the outcome module tracks the outcome (why). The Tag sets include:
1. What to tag: a specific step or an item of the PRO system, such as a patient care step, subprocess and process related with the outcome, the results through calculation, or references.
2. Where: the specific location of data generated, and the specific location where the results are sent to.
3. When: the time of data being monitored and the time of the outcome report to be generated (and/or updated) and sent out.
4. Who: the generator and receiver of the data sources and the outcome report.
5. How: how to analyze data, how to calculate the results, and how to send the report (in email, letter, telephone, etc).
   Through the mechanism of the Tag Sets, the paths of the tracking (who, what, when, where and how) are defined to monitor and manage the outcome results. At the end, the outcome will be sent out via feedback to the patient care process to facilitate understanding the Why.
   For example, to evaluate Diagnostic Outcome (the accuracy) of CTA in diagnosis of CAD, the following tag sets will be created:
1. What to tag: % coronary stenosis in the CTA report
2. Where, the specific location of data (database in the computer/server) of the CTA report from CT Labs of an imaging Dept
3. When, the triggers: as soon as the cath reports (as gold standard for comparison calculation on the same patients) generated on the same patients in real time, it send and update the results of the Diagnostic Outcome on this patient group who had CTA earlier
4. Who, the destinations: outcome report will be sent to the MD made the CTA report for a feedback;
5. How: Calculation of the accuracy is based on the model/formula of sensitivity, specificity. Then, the carriers—the report is sent out to a database that generates a report on an intranet web page and also an email to the related MD.
   Multiple tag sets can be created by different users for the same outcome with different purposes with additional info. Using the above example, a Dept Tag for Diagnostic Outcome can be created to track the interpretation performance of the Radiology Dept (using the Outcome accuracy data comparing CTA with cath). Another research tag can be created by a clinical investigator in the hospital to further investigate CTA with calcification (new info tagged) of coronary stenosis, since calcification can cause artifact that decrease the accuracy of the coronary CTA interpretation. The diagnostic outcome report on the research tagged group (who: particular patients, their reports and outcomes) with calcified stenosis (what) will be generated and send to separate personnel (where) on monthly basis (when) using emails (how). The tag sets can define the tacking path to help understanding the poor performance in this patient population (why).
   This data will be stored into system database using multiple tables (Tag table 950, Trigger table 940, Carrier table 960, and Destination table 980) as shown in FIG. 9.

### Outcome Contents and Categories

Based on the above general descriptions, a set of 15 Outcomes covers most common outcome measures in healthcare process (see table 10-1A, 10-1B, 10-2A and 10-2B. All components of the Outcomes as outlined in the 5-step process as well as the key components of the Outcomes, Tag Sets, Tracking with TAGS and Feedback. The examples of the 15 Outcomes are provided in the corresponding 10-3A, 10-3B, 10-4A, 10-4B.

A healthcare service may generate various kinds of healthcare outcomes. A healthcare outcome is a healthcare result of healthcare service selection for a patient on a patient's visit to a healthcare provider. In mathematics, all of those outcomes can be represented using outcome set which is a collection of outcomes with variety of key words for easy access.

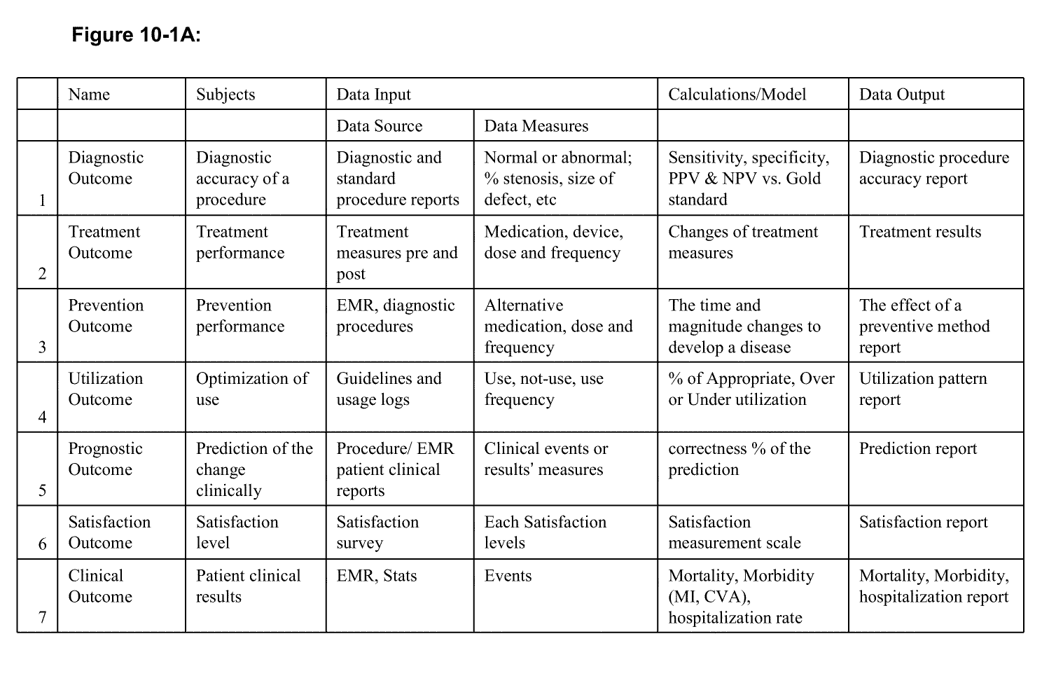

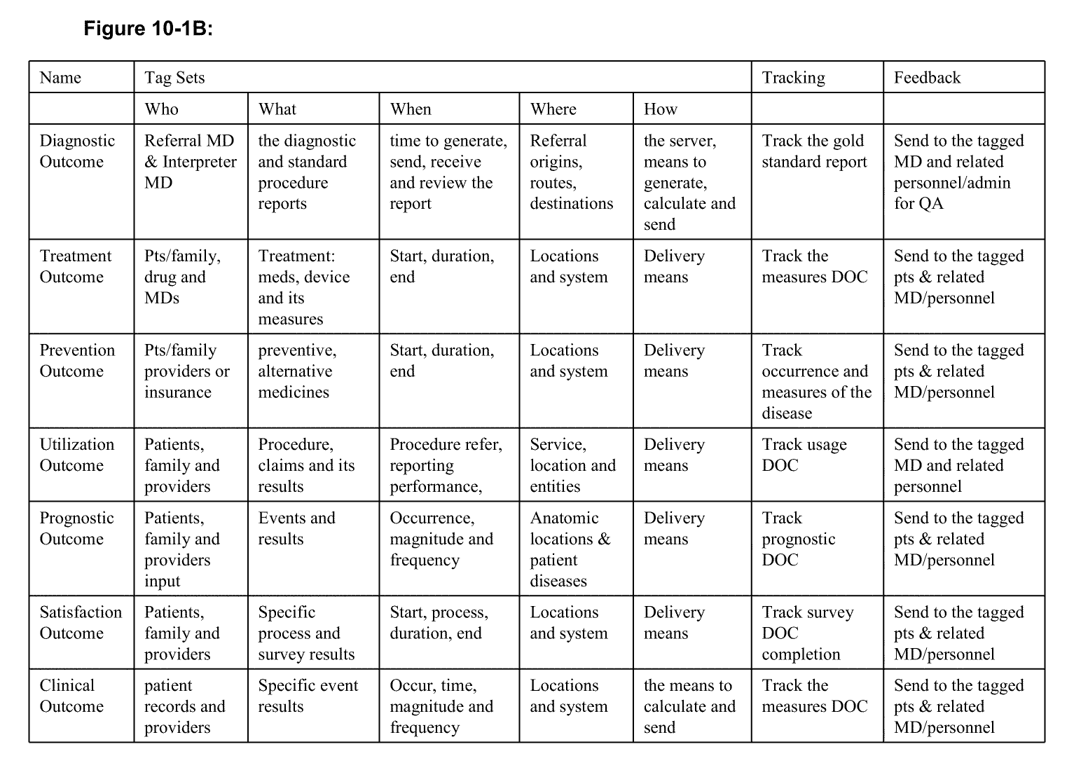

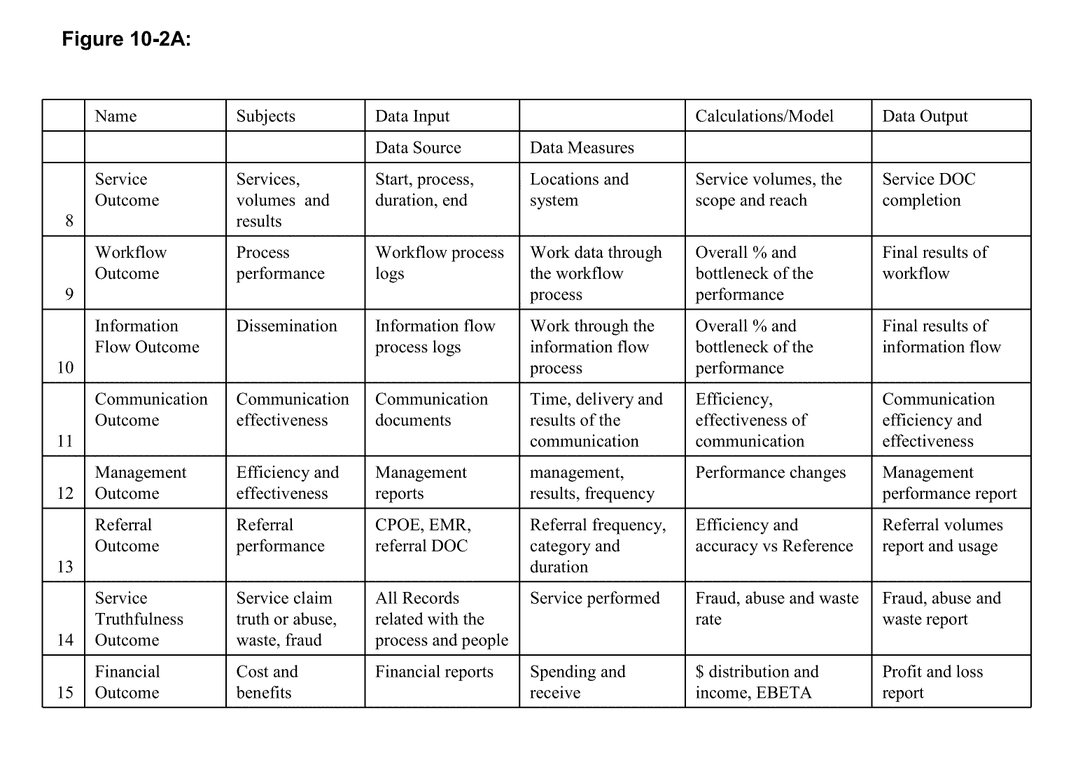

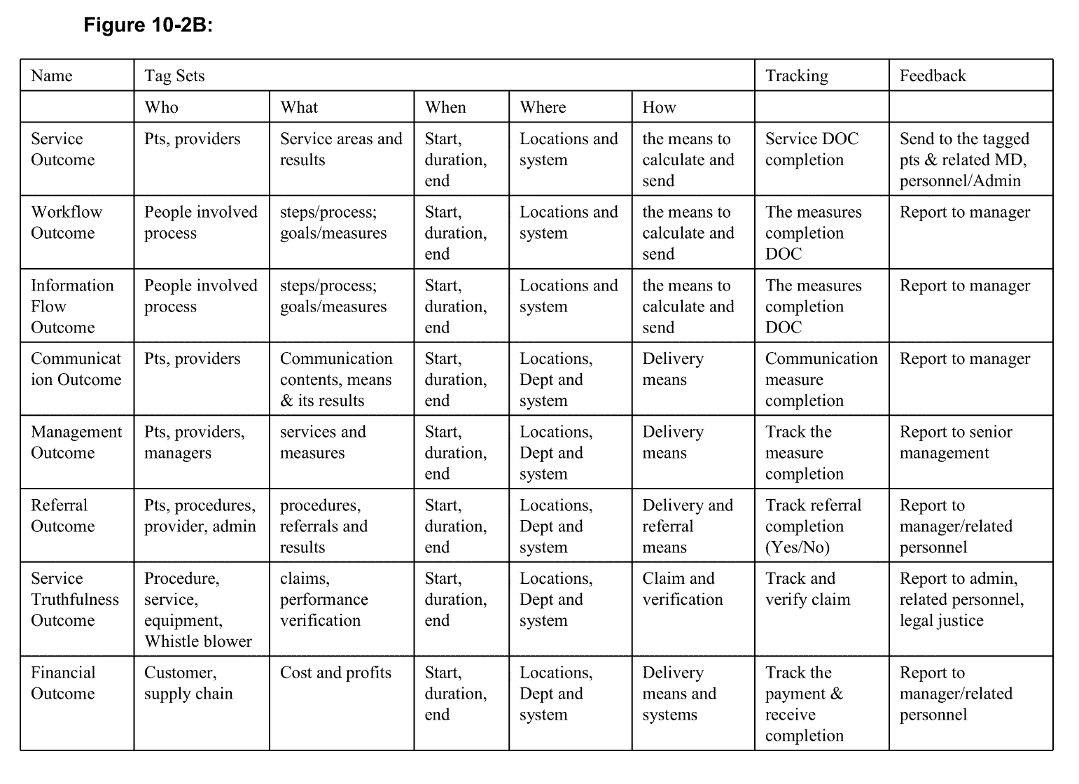

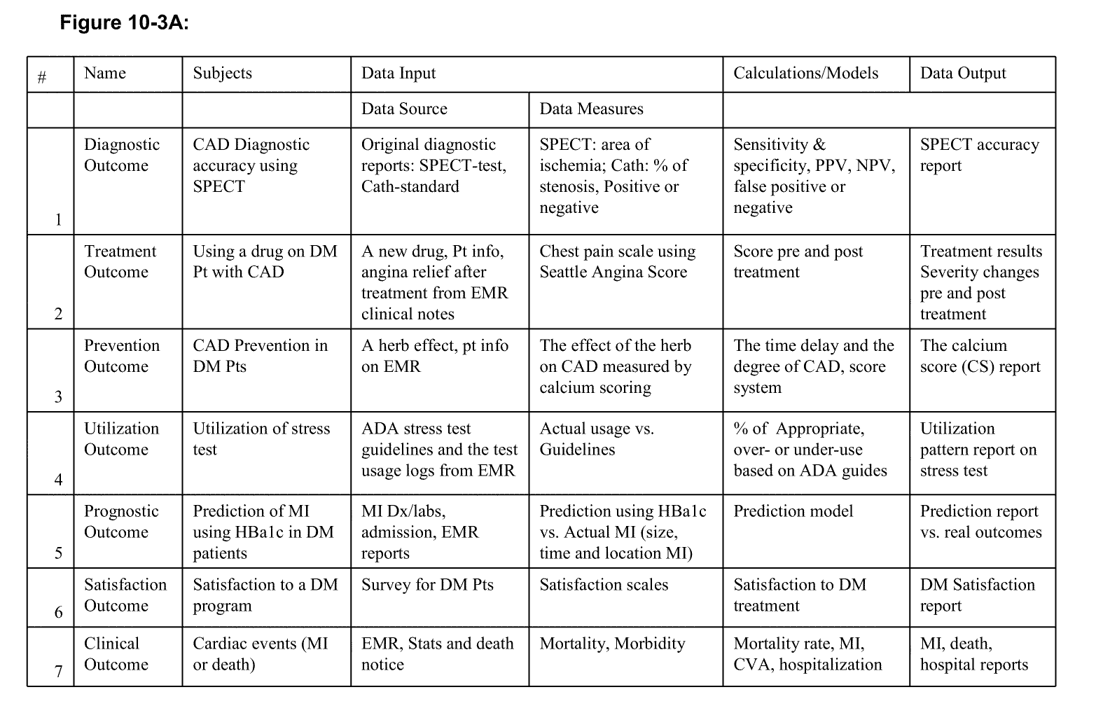

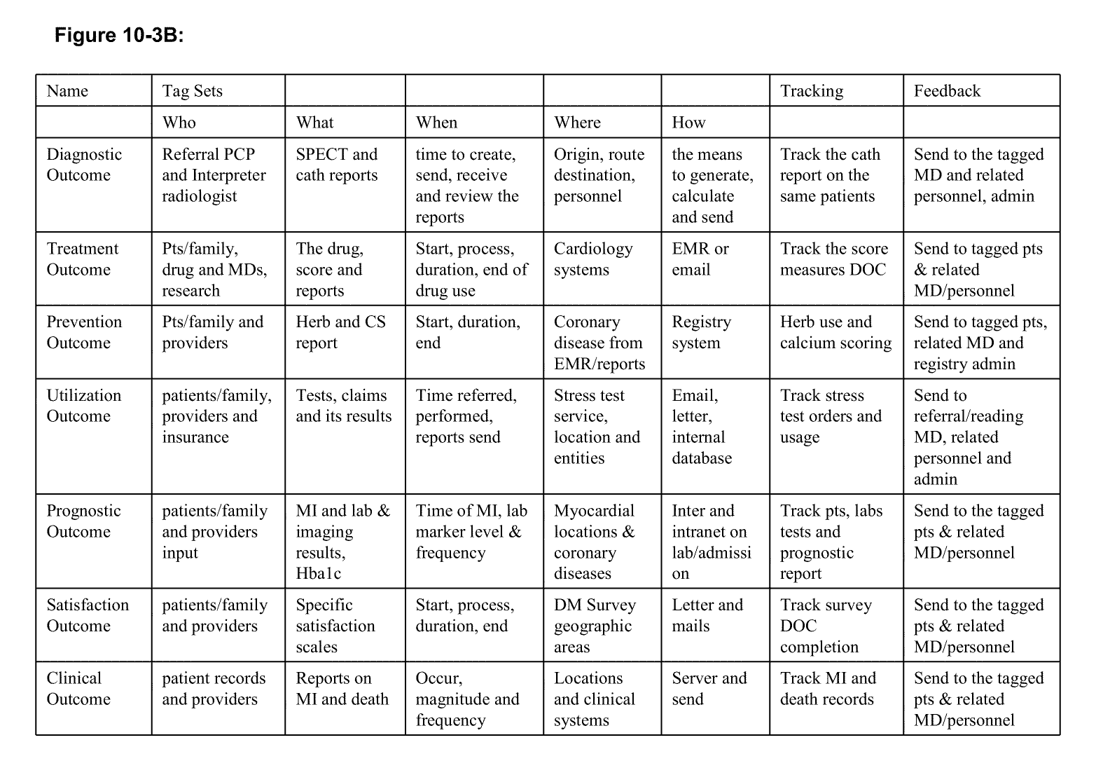

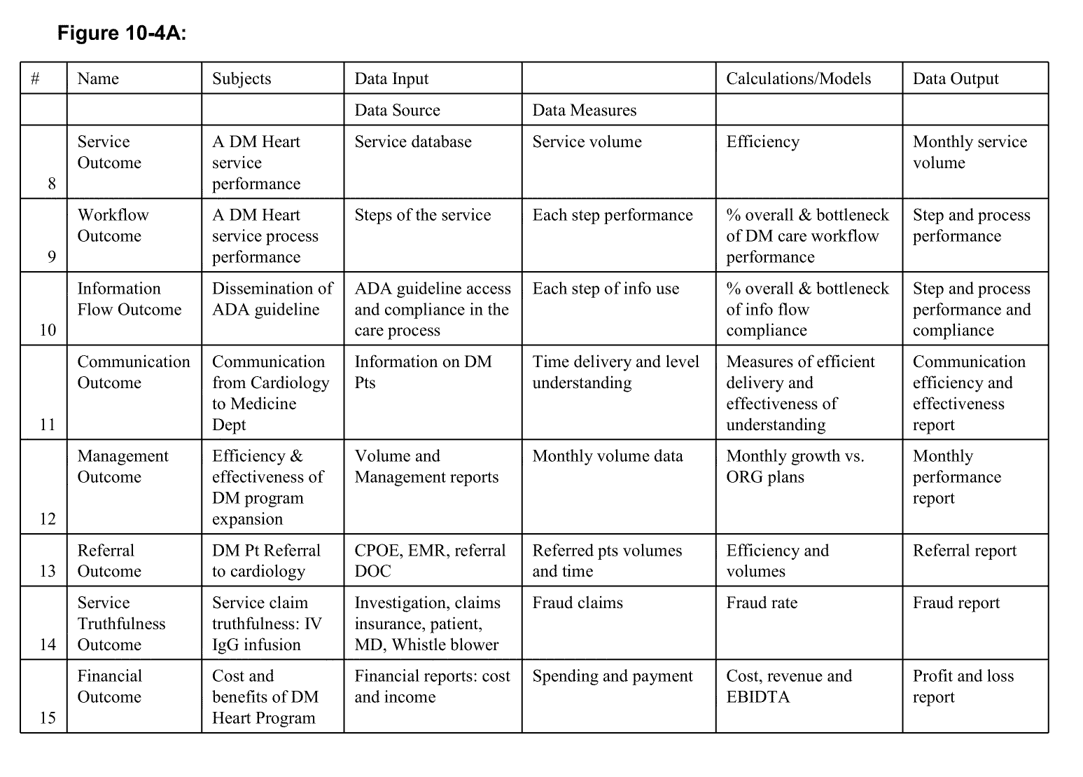

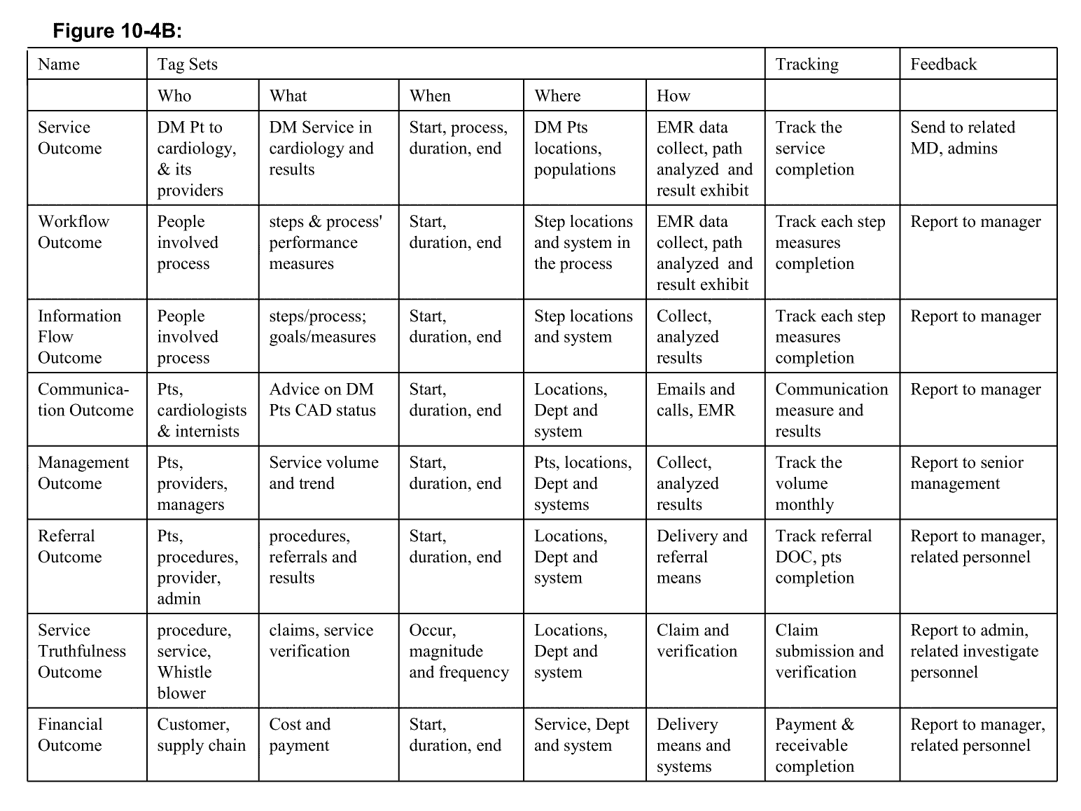

Outcome Set: {OC}=function({GL},{HP},{PT},{SC})
Where:
   GL: Reference or Guidelines
   HP: Healthcare Providers
   PT: Patients
   SC: Specific Patient Care Process
      Healthcare outcomes can be grouped into multiple categories based on their functional areas. In an exemplary embodiment, outcomes have been grouped into several categories as illustrated in FIG. 10. FIG. 10 lists the names of the outcomes, as well as their subjects, measures, calculations, tags and additional resources.

Outcome Set: OC{OC₁, . . . ,OCₙ}

### The Specific 15 Outcomes

### 1.1 Diagnostic Outcomes

### 1.1.1 Definition

Diagnostic outcome is used to measure correctness to identify or stage a disease, against actual findings (such as pathology) or acknowledged standard, such as catheterization for non-invasive stress test in diagnose coronary disease.

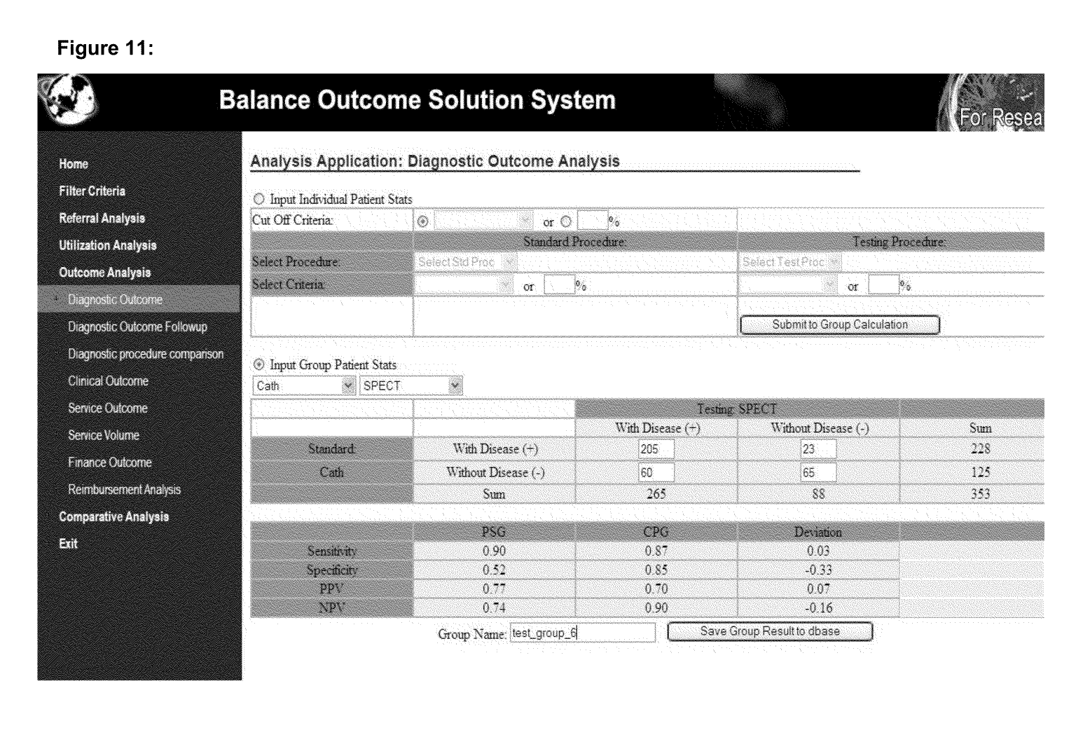

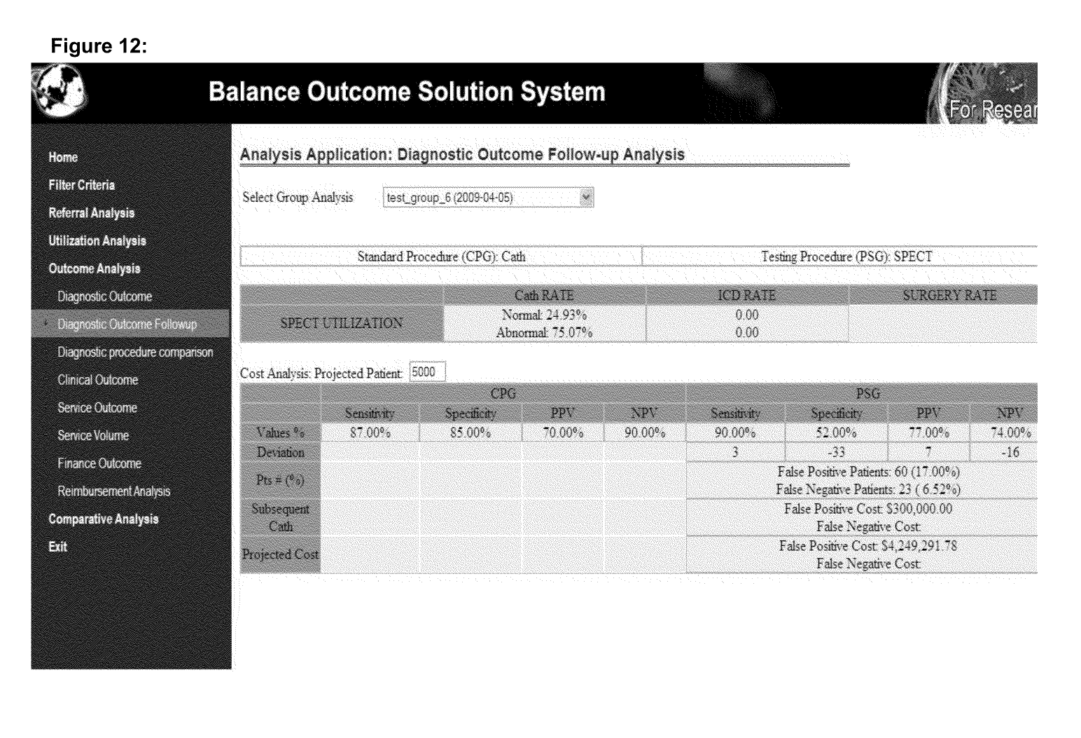

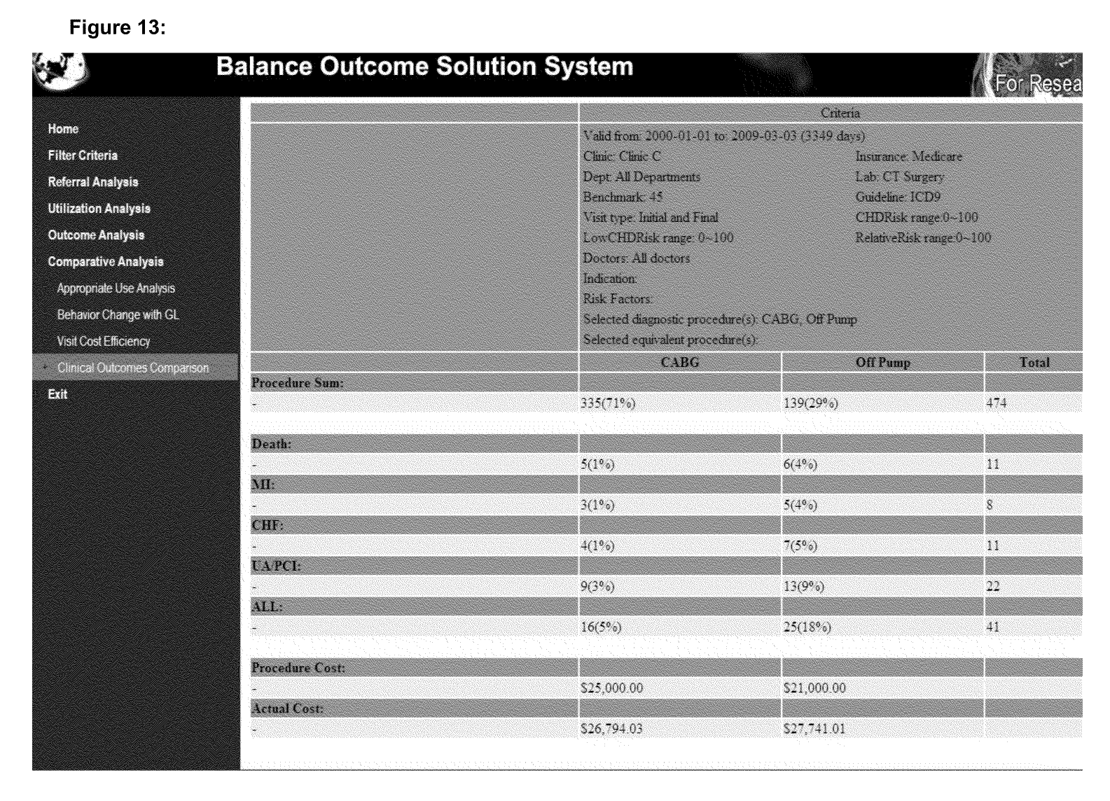

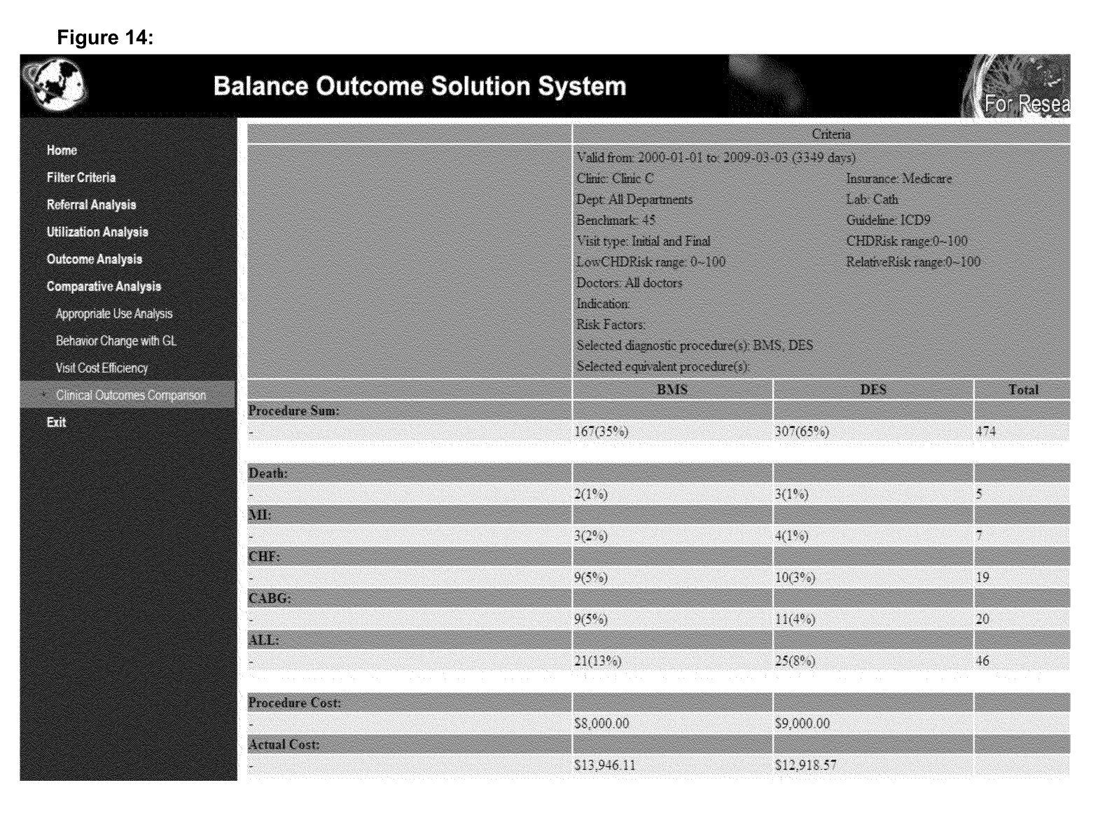

FIGS. 11 and 12 illustrate exemplary diagnostic outcome analysis GUIs from Outcome module 130. The user may elect to analyze outcomes with respect to an individual patient or with respect to a group by selecting the appropriate prompt in the GUI. The user is prompted to choose a testing procedure. The outcome module 130 calculates the Accuracy as the one of Diagnostic Outcomes, for example, the sensitivity, specificity, positive predictive value and negative predictive value.

This system provides web user interface to:
Define problems {P}
   What, when, where
   who has the problem
Define possible diagnosis {D} for a disease as a Problem
Input guideline or reference for diagnosis {GS}
Track and analyze Diagnostic outcomes

{OC_{jd}}=Function({P},{D}, . . .

### 1.1.2 Tracking

Identify a group of patients with diseases as Problems {P′}<({P}
Collect a group of diagnostics {D} of patients with disease as Problem {P}
Collect the diagnosis using standard procedure: {GS}
Collect the real findings {F} about the causes: {F}

### 1.1.3 Analysis

Calculate Diagnostic accuracy: compare the diagnostics {D} with standard diagnosis {GS} or with real findings {F}
Evaluate outcome: how many items in {D} match with {F}

{OC_{jd}}=Function({P},{D},{GS},{F})

A user may define the function for calculating Diagnostic outcomes. In an exemplary embodiment, the function for the {O_{jd}} is defined as the following: assume that there are X healthcare diseases/problems and each disease/problem has one or multiple diagnostics about the disease/problem. Totally, we have Y diagnostics. For every diagnosis result, we may have a real finding. Or, we may get a standard diagnosis for every diagnosis result. Of those Y diagnoses, Z diagnoses are matched with real findings or standard diagnosis. We may calculate the {O_{jd}} using Z divided by Y.

### 1.2 Treatment Outcomes

### 1.2.1 Definition

Treatment outcome is used to measure the effectiveness of a treatment for a health problem/disease to be treated. In healthcare, every treatment needs to follow treatment guidelines or recommendations. For example, for certain patient symptoms or indications, healthcare guidelines will recommend specific treatments for the patient. Healthcare treatments should match with the guideline recommendations.

In addition, each treatment serves one or multiple goals. Actual results of the treatments may or may not match/reach the treatment goals. Treatment outcomes focus on the differences between the actual results and the intended goals for treatment of the disease or problem. In this embodiment, Treatment outcomes include treatment decision making for healthcare, i.e., what treatment was ultimately decided upon. In addition, treatment outcomes include treatment results, i.e., whether the treatment alleviated the symptoms or improved the function or life.

This embodiment provides web user interface to:
Define problems {P}
Define possible treatments for problems {T}
Input guideline or reference for treatments {GS}
Define treatment goals {G}
Define how to collect treatment results {RE}
Track and analyze Treatment outcomes

{OCₜₘ}=Function({P},{T},{GS},{RE},{G})

### 1.2.2 Tracking

Identify a group of problems {P′}<{P}
Collect a group of treatments {T′}<{T}
Collect results after treatments {RE}

### 1.2.3 Analysis

Compare the treatments {T′} with guidelines {GS}: how many treatments {T′} match with {GS}
Calculate Treatment's effectiveness: compare treatment results {RE} with treatment goals {G}
Evaluate outcome:

{OCₜₘ}=Function({P},{T},{RE},{GS},{G})

A user may define the function for calculating Treatment outcomes, such as reach a level of effectiveness measured in a blood test, imaging test, symptoms or signs relief, or even patient numbers, etc. For example, one doctor has 100 patients with established coronary disease, whose LDL cholesterol values above 100. Based on Clinical Practice Guidelines, the LDL level needs to be <70. Over 1 year with statin treatment, 80 patients reached the goal. His treatment outcome {OCₜₘ} can be calculated by: {OCₜₘ}=80% (80 divided by 100).

### 1.3 Prevention Outcomes

### 1.3.1 Definition

Prevention outcome is used to measure the effectiveness and efficiency of a prevention method for a health problem disease, complication or even death. Like treatment, prevention needs to follow prevention guidelines or recommendations as well. For example, for certain guidelines will recommend specific prevention for patients with certain indications or future problems. Healthcare prevention should match with the guideline recommendations.

In addition, each prevention may serve one or multiple goals. Actual results of the preventions may or may not match/reach the prevention goals. Prevention outcomes focus on the differences between the actual results and the intended goals for prevention of the disease or problem in the future. In this embodiment, Prevention outcomes include prevention decision making for healthcare, i.e., what prevention is ultimately decided upon. In addition, prevention outcomes include prevention results, i.e., whether the prevention effectively (magnitude) and efficiently (duration of time) keep the patients from the disease, complications or death.

This embodiment provides web user interface to:
Define problems {P}
Define possible preventions for problems {Pr}
Input guideline or reference for preventions {GS}
Define prevention goals {G}
Define how to collect prevention results {RE}
Track and analyze prevention outcomes

{OC_{Pr}}=Function({P},{Pr},{GS},{RE},{G})

### 1.3.2 Tracking

Identify a group of problems {P′}<{P}
Collect a group of preventions {Pr′}<{Pr}
Collect results after prevention {RE}

### 1.3.3 Analysis

Compare the preventions {Pr′} with guidelines {GS}: how many preventions {Pr′} match with {GS}
Calculate Prevention's effectiveness: compare treatment results {RE} with prevention goals {G}
Evaluate outcome:

{OC_{Pr}}=Function({P},{Pr},{RE},{GS},{G})

A user may define the function for calculating Prevention outcomes, such as reach a level of effectiveness measured in a blood test, imaging test, symptoms or signs relief, complications or even death, etc. For example, one doctor has 100 patients with established cardiomyopathy, whose LVEF values <30%. Based on Clinical Practice Guidelines, the patients need AICD. Over 1 year with AICD treatment, 60 patients alive. The prevention outcome {OCₚᵣ} of mortality can be calculated by: {OC_{Pr}}=60% (60 divided by 100).

### 1.4 Utilization Outcomes:

### 1.4.1 Definition

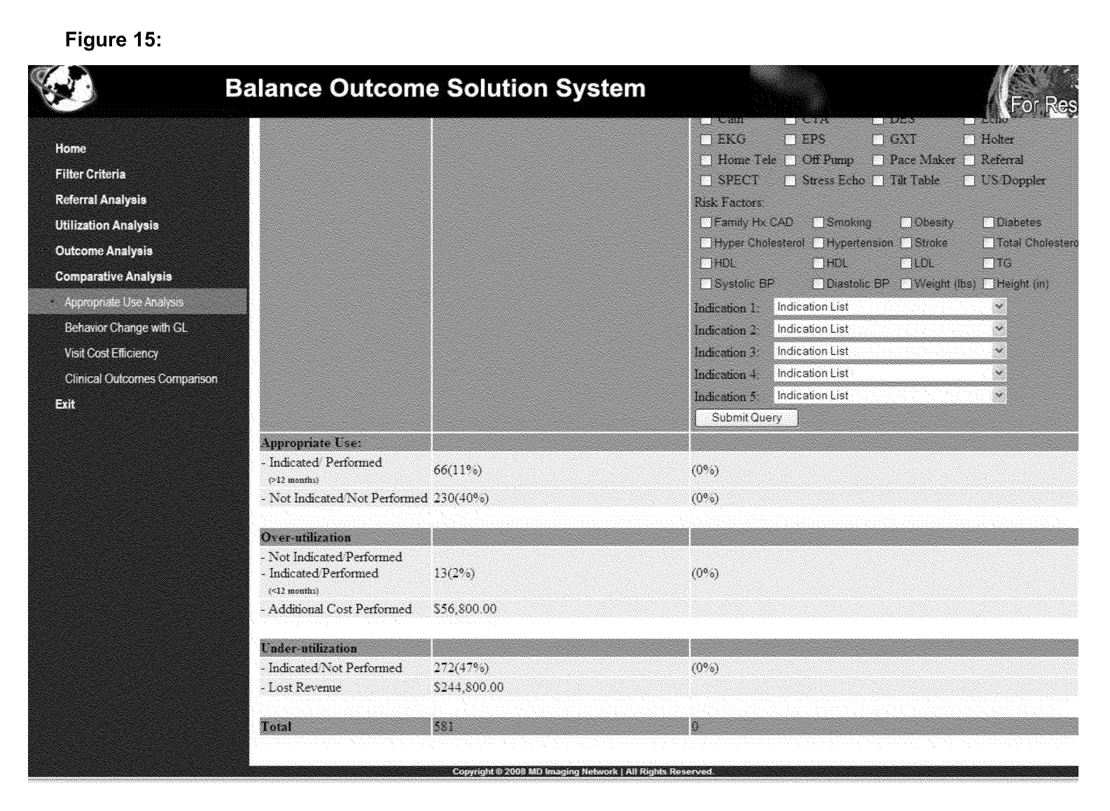

FIGS. 15 to 18 illustrate exemplary utilization outcome analysis GUIs from Outcome module 130. Utilization outcome is used to measure resource utilization: volumes, costs, labors and distributions. Utilization outcome can be evaluated by comparing the resource utilization for one group of resources with the resource utilization of another group of resources.

Another possible scenario of evaluating Utilization outcome is to compare the resource utilization with requirements from Reference module. If a resource should be used, but, it is not used, the resource is under-utilized. If a resource should not be used, but, it is used, the resource is over-utilized. Both under-utilization and over-utilization should be avoided to reach optimal results for a resource management system. For example, it is desirable to measure the outcomes of using a new technology.

This system provides web user interface to:
Define resources {R}
Define use or work load for resources {WL}
Input guideline or reference for utilization {GS}
Track and analyze Utilization outcomes

{OCᵤₜ}=Function({R},{GS},{WL})

A user may define the function used for calculated Utilization outcomes. One of exemplary functions using in this invention can be found in Table 3.

### 1.4.2 Tracking

Identify resources {R}
Collect data about work loads for resources {WL}

### 1.4.3 Analysis

How many resources in {R} of which the work loads {WL} match with references {WG}
Compare the work loads {WL} for different resource groups
   For example, compared with Clinical Practice Guidelines (CPG) of SPECT imaging in total # of patients, one can use # patients not-indicated but had test to assess % of over-utilization; and use # patients indicated but did not have the test, % of under-utilization.

### 1.5 Predictive or Prognostic Outcome

### 1.5.1 Definition

Future results may be predicted based on current available data and models. Predictive outcome is used to measure correctness of a group of predictions. For example, it is desirable to measure the prognostic outcomes of using a new drug to treat patients with hypercholesterolemia.

This system provides web user interface to:
Define the subjects {SB}
Define possible future results for the subjects {FR}
Track and analyze Predictive outcomes

{OCₚₚ}=Function({SB},{FR})

### 1.5.2 Tracking

Identify subjects {SB}
Collect a group of predictions {PR} about the future results: {PR}<{FR}
Collect the real findings about the future results: {F}<{FR}

### 1.5.3 Analysis

Evaluate outcome: how many subjects in {SB} of which the future results {PR} match with {F}

{OCₚₚ}=Function({SB},{PR},{F}

A user may define the function for calculating Predictive outcomes. In an exemplary embodiment, the Predictive outcome is defined as the following: assume that there are X healthcare subjects and each subject has one or multiple predictions about the subject. In total, we have Y predictions. For every prediction, we will have a real finding. Of those Y predictions, Z predictions are matched with real findings. We may calculate the {OCₚₚ} using Z divided by Y.

### 1.6 Satisfaction/Mentality Outcomes

### 1.6.1 Definition

Satisfaction outcome is used to measure patient's happiness and satisfaction to an aspect of healthcare service, such as speed of care (testing or other procedures) and waiting time for care.
Patients use services for healthcare.
There may be multiple measure service quality, such as patient happiness and satisfaction.
Use a Satisfaction score to measure satisfaction from multiple areas.
Ideally, the higher a Satisfaction score, the better using industrial standard of Satisfaction score or measures for comparison.
   This embodiment provides web user interface to:
Define services {S}
   What, when, where
   From who to whom
Define measure areas {MA}
Define how to calculate Satisfaction Score {SS}
Input industrial standards about service quality and/or about Satisfaction Score {GL}
Track and analyze Satisfaction outcomes

{OCₛₘ}=Function({S},{SS},{GL}

### 1.6.2 Tracking

Identify services {S}
Identify measure areas {MA}
Collect feedback {F} in measure areas {MA}

### 1.6.3 Analysis

Calculate Satisfaction score {SS} from feedback {F}
Evaluate outcome: compare Satisfaction scores

{OCₛₘ}=Function({S},{MA},{F},{SS},{GL})

A user may define the function for calculating Satisfaction outcomes. In an exemplary embodiment, the Process Module 110 collects patient satisfaction scores using a web survey. The survey asks patients to give their satisfaction scores in 3 measure areas (hsₐ, hs_{b} and hs_{c}) for healthcare services. For each measure area, patients can give a Satisfaction score from 1 to 5. The simplest function of the Service outcomes is: {OCₛₘ}=(Score for hsₐ)+(Score for hs_{b})+(Score for hs_{c}).

### 1.7 Clinic Outcomes

### 1.7.1 Definition

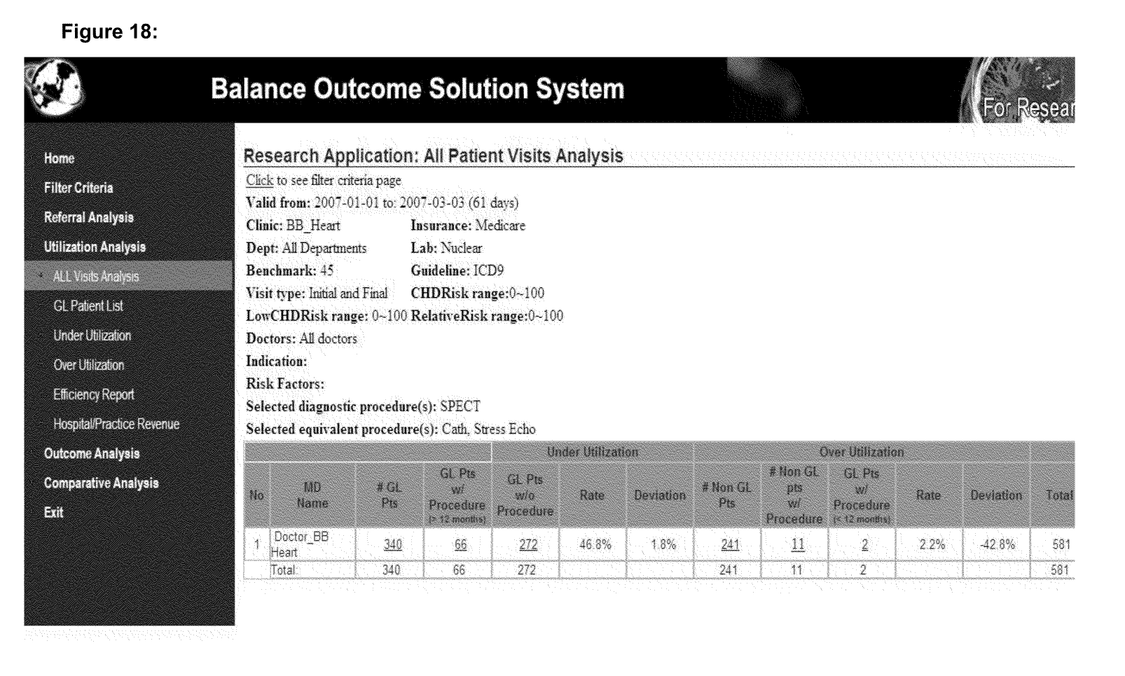

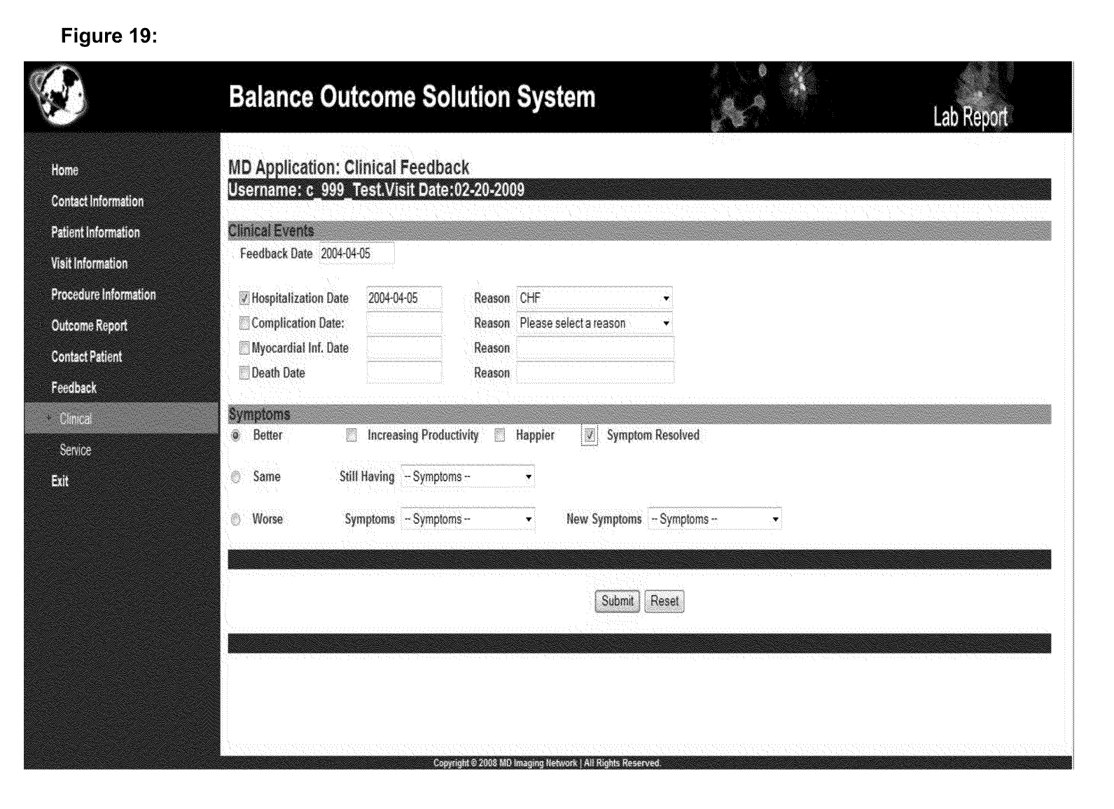

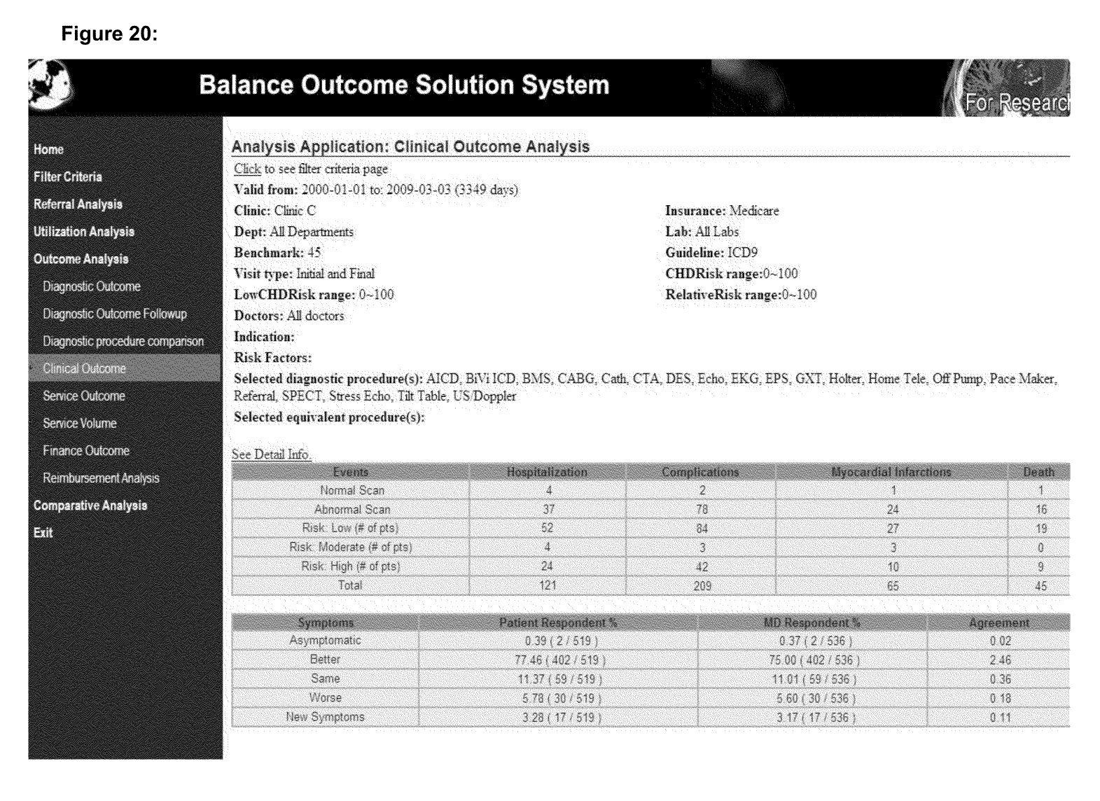

In this embodiment, Clinic outcomes include complications or morbidity, mortality, longevity and/or quality of life. FIGS. 19 and 20 illustrate exemplary clinical outcome GUIs, including a patient feedback form and a clinical outcome report. The patient feedback form collects the clinic information after a healthcare service. The clinic outcome report categorizes and provide details: in the number of patients/doctors in outcome management system 100 who have been hospitalized, have complications, have myocardial infarctions, have died, and have symptoms improvement. The management system 100 compares Clinic outcomes from different healthcare providers. It also compares Clinic outcomes with guideline or reference requirements.

This system provides web user interface to:
Define patients {PT}
Define subjects {SB}
   morbidity, mortality, longevity, etc
Input guidelines or references about clinic outcome {GL}
Track and analyze Clinic outcomes

{OC_{cl}}=Function({PT},{SB},{GL})

### 1.7.2 Tracking

Identify a group of patients {PT}
Collect information about the subjects {SB}, for example, count patients in the patient groups who have morbidity

### 1.7.3 Analysis

Calculate the outcome scores
Evaluate outcome: compare outcome scores

{OC_{cl}}=Function({PT},{SB},{GL})

A user may define the function for calculating Clinic outcomes. For example, there are 200 patients in a specific patient group (ages: 60 to 65, with heart attacks, and being given an XYZ treatment). Among those patients, 15 had another heart attack within 5 years. The Clinic outcome score of the XYZ treatment is: {OC_{cl}}=7.5% or (5/200).

Service Outcomes

### 1.7.4 Definition

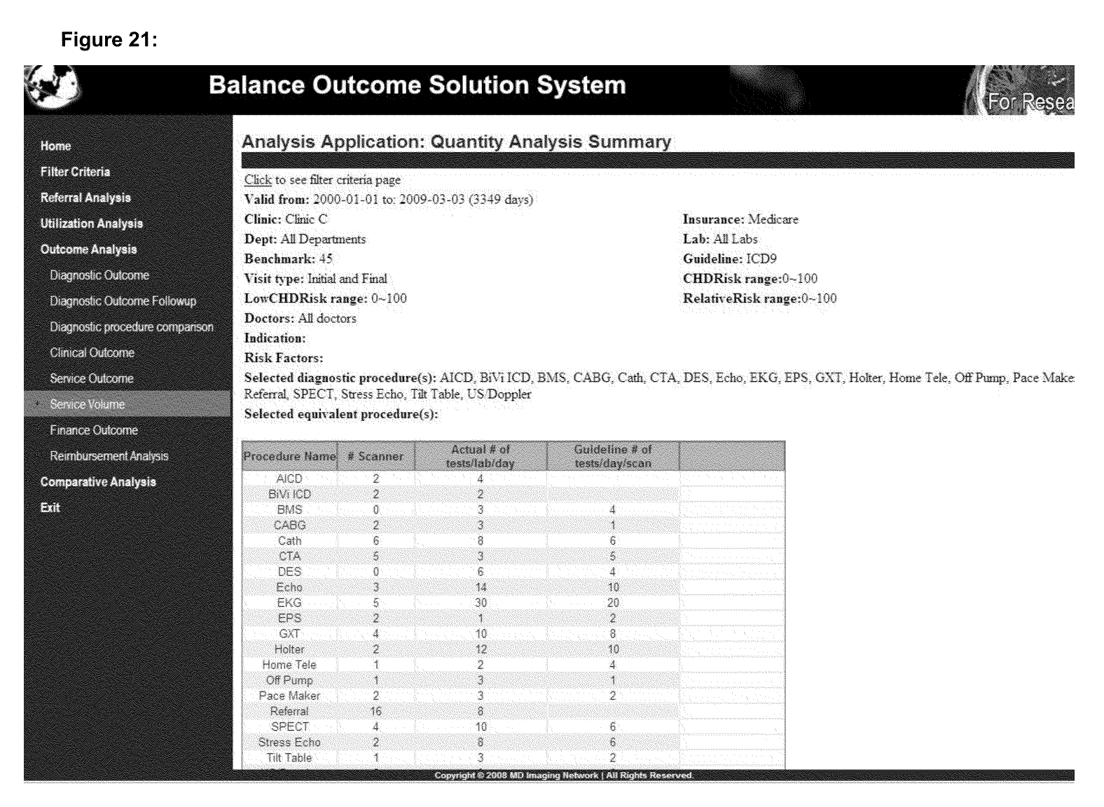

Service outcome is used to measure service efficiency for a healthcare provider. Service outcome can compare service speed between one service provider and another. It can also be used for comparing the services with requirements from an industrial guideline or reference. FIG. 21 illustrates an exemplary service outcome GUI including a service outcome report illustrating the number of scanners used for the clinic. The report contains the subjects, the number of tests/lab procedures performed per day and the guideline recommended number of tests per day per scan.

This system provides web user interface to:
Define services {S}
Define service resources {SR}
Define service measurement {MA}
Input guidelines or references for services {GL}
Track and analyze Satisfaction outcomes

{OCₛₒ}=Function({S},{SR},{MA},{GL})

### 1.7.5 Tracking

Identify services {S}
Identify service resources {SR}
Collect information about the measurement: for example, how many jobs being done on each service resources

### 1.7.6 Analysis

Calculate outcome score based on the data being collect
Evaluate outcome: compare Service scores

{OCₛₒ}=Function({S},{SR},{MA},{GL})

A user may define the function for calculating Service outcomes. For example, there are 2 Ultra Sound machines in a laboratory. In an exemplary week, the laboratory finished 24 Ultra Sound tests. The Service outcome of the Ultra Sound test for that laboratory is: {OCₛₒ}=24/2.

### 1.8 Workflow Outcomes

### 1.8.1 Definition

A workflow may consist of multiple working steps. A group of working resources may contribute to each work step. Workflow outcome is used for measuring Effectiveness/Efficiency of workflows in healthcare services:
evaluating the working steps as a group
evaluating individual working step:
evaluating working resources:
evaluating working flow against working flow guideline if needed
   For example, it is desirable to measure the outcomes of the performance of a service workflow.

This system provides web user interface to:
Define workflow with working steps {WS}
   What, when, where
   Working resources
Define working resources {WR}
Define system performance {SP}
Input guidelines or references for working flow {GL}
Track and analyze Workflow outcomes

{OC_{wo}}=Function({SP},{WS},{WR},{GL})

### 1.8.2 Tracking

Identify work steps {WS} and working resources {WR}
Measure system performance {SP} for each step and entire workflow

### 1.8.3 Analysis

Compare system performance for different workflows
Evaluate individual working steps: positive or negative
Evaluating working resources about contributions
Evaluating working flow against working flow guideline if needed
Evaluate outcome:

{OC_{wo}}=Function({SP},{WS},{WR},{GL})

A user may define the function for calculating Workflow outcomes. In an exemplary embodiment, the evaluation function can be defined as the performance of patient process time. The short time delay in patients' clinic visits will be good for both patients and healthcare providers. A patient visit is processed by multiple steps of a patient care process at a clinic or hospital, such as registration, meeting with a doctor, procedures, etc. For an individual visit, some steps may be efficient, i.e. taking less time, which saves clinic time (x minutes). Other steps of the process may not as efficient which costs extra time (y minutes). The Workflow outcome can be evaluated by: {OC_{wo}}=ΣX+ΣY where SP is time delay; WS includes registration, meeting with doctor, procedures, etc.

### 1.9 Information Flow Outcomes

### 1.9.1 Definition

Information Flow Outcome evaluates performance of information process for healthcare services. An Information flow may consist of multiple process steps and sequence of the process. An Information flow may use multiple information sources. A group of working resources may contribute to each process step. Information Flow outcome is used for measuring Effectiveness/Efficiency of information process:
evaluating the process steps as a group by comparing with different groups of information processes.
evaluating individual process steps to determine whether the individual process step is a positive contribution or negative contribution to the information flow
evaluating information sources: positive contribution or negative contribution
evaluating work resources: positive contribution or negative contribution
evaluating information flow against information flow guideline if needed
   For example, it is desirable to measure the outcomes of a guideline implementation to see how the information affects the physician's behavior. This system provides web user interface to:
Define information sources {IS}
Define process steps {PS}
Define system performance for information process {SP}
Input guidelines or references for information flow {GL}
Track and analyze Information Flow outcomes.

{OC_{if}}=Function({IS},{PS},{SP},{GL})

### 1.9.2 Tracking

Identify information sources {IS}
Identify process steps {PS}
Identify processing resources {PR}
Measure system performance {SP} or adoption for every information process

### 1.9.3 Analysis

Compare system performance for different information flows
Evaluating individual process step: positive contribution or negative contribution to the information flow
Evaluating information sources about contributions
Evaluating processing resources about contributions
Evaluating information flow against information flow guideline if needed
Evaluate outcome:

{OC_{if}}=Function({IS},{PS},{SP},{GL})

A user may define the function for calculating Information Flow outcomes. In an exemplary embodiment, the function is similar to the Workflow outcomes: {OC_{if}}=ΣX+ΣY. The x is the time saved by information process steps for an individual visit. The y is the extra time by some information process steps for an individual visit.

### 1.10 Communication Outcomes

### 1.10.1 Definition

Communication is a key factor for the performance of healthcare providers. Communication may be affected by many elements:
Who initiates the communication
When the communication is triggered
Which media is used as communication channel
Where is the destination of communication
How the communication works
   Communication outcomes are used to evaluate communication quality. For example, it is desirable to measure the outcomes of a diagnostic CT scan report to see how well the referral doctor and the patient understand the report.

Communication outcome can be evaluated by comparing the outcome from one group of healthcare services with the outcome of another group of healthcare services. It can also be used to compare the communication outcome of healthcare services with requirements from Reference module.

This system provides web user interface to:
Define contribution elements for communication {CE}
Define how to measure communication quality {CQ}
Input guidelines or references for communication quality {GL}
Track and analyze Communication outcomes.

{OC_{cm}}=Function({CE},{CQ},{GL})

### 1.10.2 Tracking

Identify contribution elements {CE}
   Who initiates the communication: doctors, nurses, technicians, etc.
   When is the communication triggered
   Which media is used as communication channel: paper notes, phone calls, emails, etc
   Where is the destination of communication: doctors, nurses, technicians, etc.
Measure communication quality

### 1.10.3 Analysis

Compare communication quality by service groups of healthcare
Compare communication quality with guidelines or reference

{OC_{cm}}=Function({CE},{CQ},{GL})

A user may define the function for calculating Communication outcomes. For example, 100 patients were diagnosed to have severe or critical coronary disease using CTA scan in January. These patients need to be revascularized (bypass surgery or stent) and the reports need to be sent within 4 hours based on the guideline or reference. The actual outcomes: total of 70 patients revascularized and 80 patients' reports were sent within 4 hours. Therefore, the effectiveness of Communication Outcome shall be 70/100 (70%) and the efficiency of the Communication Outcome, will be 80/100, 80%, in this case.

### 1.11 Management Outcomes

### 1.11.1 Definition

For management tasks, different management system or delivery skills may generate different performance for healthcare services. Many factors contribute to management skills:
Planning: identification of business goals and the ways to reach it.
Organizing: assignment of tasks and allocations of resources throughout the business organization.
Coordination: track the activities based on the goal and adjust the actions.
Control: provide guidance.
   Management outcome is used to evaluate effectiveness and efficiency of management in healthcare. For example, it is desirable to measure the outcomes of efficacy and effectiveness of the management inside an emergency department.

Management outcome can be evaluated by comparing the outcome from one group of healthcare services with the outcome of another group of healthcare services. It can also be used to compare the management outcome of healthcare services with requirements from Reference module.

This system provides web user interface to:
Define management tasks {MT}
Define how to measure effectiveness and efficiency of management for each task {EE}
Input guidelines or references for healthcare management {GL}
Track and analyze Management outcomes

{OCₘₜ}=Function({MT},{EE},{GL})

### 1.11.2 Tracking

Identify management tasks {MT}
Measure effectiveness and efficiency of management for each task {EE}

### 1.11.3 Analysis

Evaluate outcome: compare Management outcomes

{OCₘₜ}=Function({MT},{EE},{GL})

A user may define the function for calculating Management outcomes. In an exemplary embodiment, the management of an emergency department is evaluated by the response time when an emergent care is needed. The management tasks include personal management, priority management and equipment management. The personal management handles working schedules for every medical staff. The priority management is to do the high priority tasks 1^{st}. The maintenance of equipment has to be well scheduled to increase the availability. For example, managing patients with acute chest pain (ACP) in the ER can be done with ACP Pathway with special RN (personnel) to do an ECG followed by CTA scan, if ECG negative (equipment) immediately before a regular patient in the ER (priority). For different schedules, the response time t is collected. The Management outcome is calculated by: {OCₘₜ}=(summary of response time) divided by (the number of emergency cases).

### 1.12 Referral Outcomes:

### 1.12.1 Definition

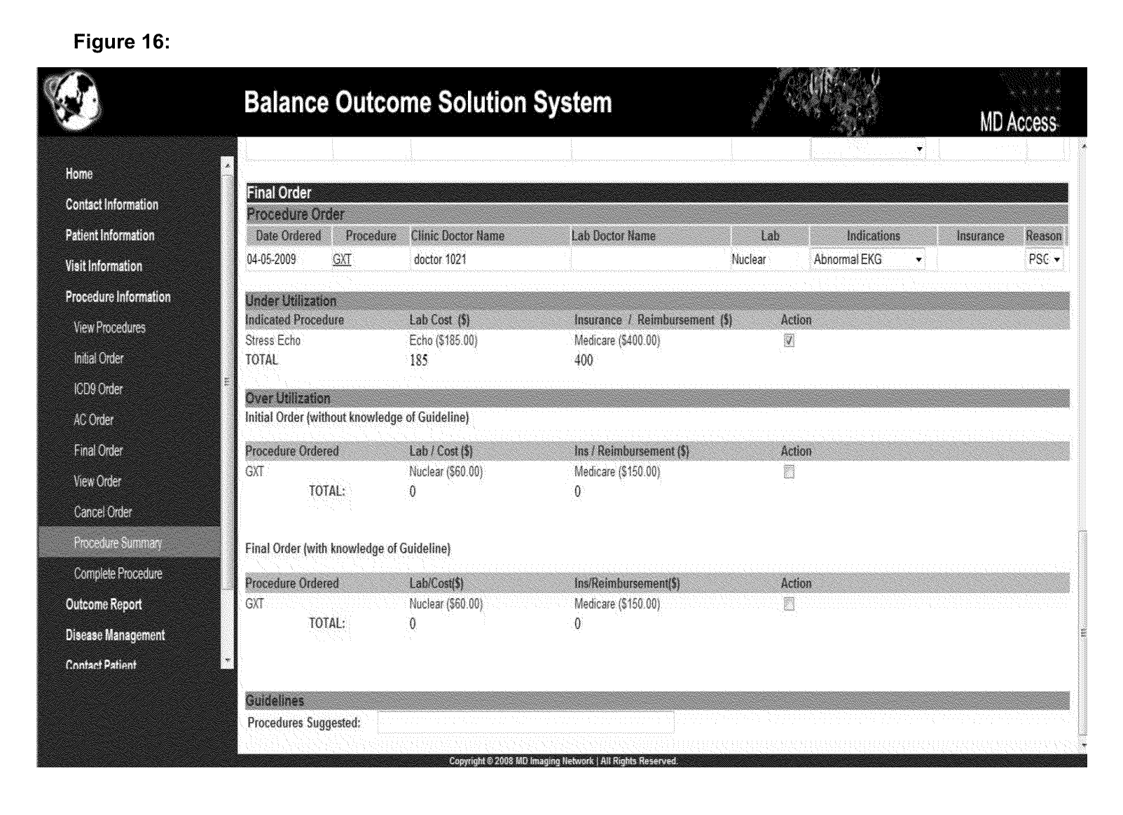

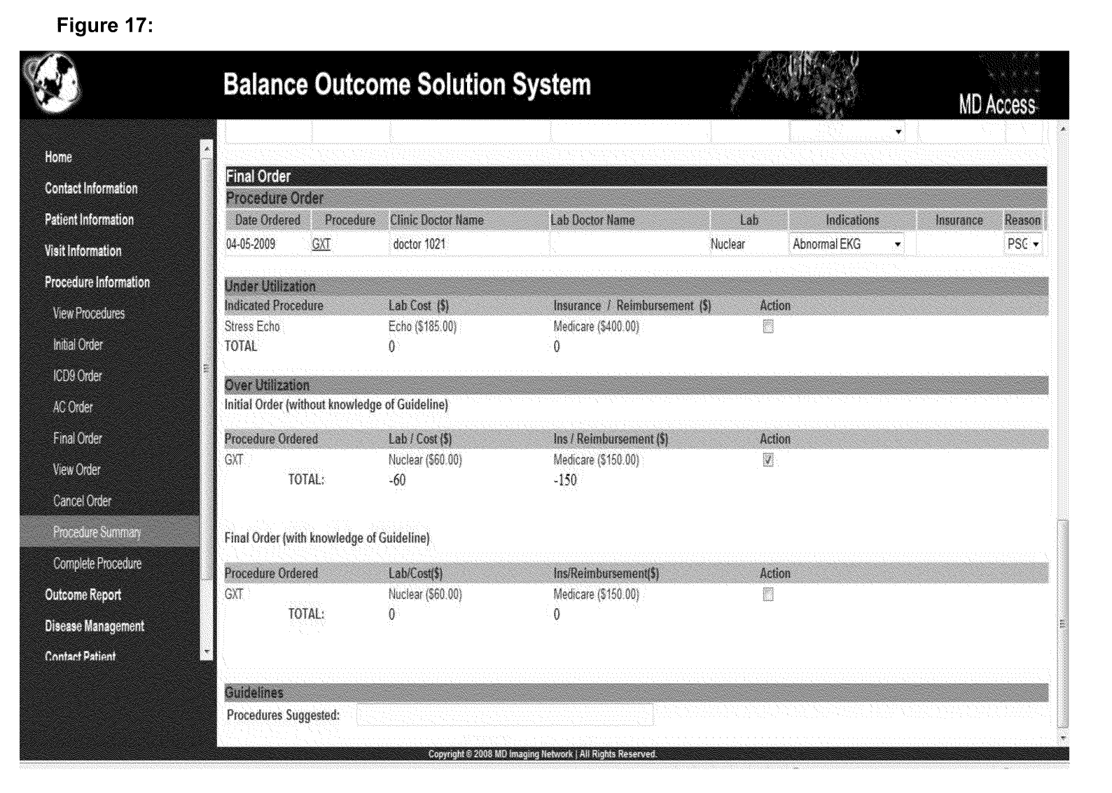

FIGS. 16 and 17 illustrate exemplary referral and referral outcome GUIs from Outcome module 130. Referral outcome is used to measure Referral performance: volumes, Reference (or Standard) compliance and associated other outcomes such as Utilization Outcomes or Financial Outcomes. Referral outcome can be evaluated by comparing the Referral utilization between 2 groups of referrals.

Another possible scenario of evaluating Referral outcome is to as Referral efficiency and accuracy compared to Reference module.

This system provides web user interface to:
Define Referrals {R}
Define Referral levels—such as volumes, frequency {RL}
Input guideline or reference for Referral {GS}
Track and analyze Referral outcomes

{OC_{RL}}=Function({R},{RL},{GS})

A user may define the function used for calculated Referral outcomes. One of exemplary functions using in this invention can be found in Table 10.

### 1.12.2 Tracking

Identify Referral resources {R}
Collect data about Referral levels—volumes, frequency {RL}

### 1.12.3 Analysis

How many Referrals in {R} of which the Referral levels {RL} match with references {WG}
Compare the Referral levels {RL} for different resource groups
   For example, compared with Clinical Practice Guidelines (CPG) of SPECT imaging, one can calculate # patients referred in a months, % of SPECT referrals compliant with Guidelines.

### 1.13 Service Truthfulness Outcomes

### 1.13.1 Definition

Service truthfulness outcome, a subset of Service Outcome, is used to measure whether service is completely, partially or not rendered in a patient care process. Service truthfulness outcome can compare with reference/standard accepted margin of errors in a patient care process. The truthfulness usually provided by patients, their family members, whistleblower or providers. It can be used in waste and fraud detection and management.

This system provides web user interface to:
Define services {S}
Define service verification {SR}
Define service measurement {MA}
Input guidelines or references for services {GL}
Track and analyze Satisfaction outcomes

{OCₛₒ}=Function({S},{SR},{MA},{GL})

### 1.13.2 Tracking

Identify services {S}
Identify service resources {SR}
Collect information about the measurement: for example, how many jobs being done on each service resources

### 1.13.3 Analysis

Calculate outcome score based on the data being collect
Evaluate outcome: compare Service scores

{OCₛₒ}=Function({S},{SR},{MA},{GL})

A user may define the function for calculating Service outcomes. For example, there are 2 Ultra Sound machines in a laboratory. In an exemplary day, the laboratory claimed 20 Ultra Sound tests. Out of the 20, only 16 were verified and the rest 4 were not truthfully performed. The Service truthfulness outcome of the Ultra Sound tests for that laboratory is: {OC₅₀}=16/20, 80% or fraud rate is 4/20 (20%).

### 1.14 Financial Outcomes

### 1.14.1 Definition

Financial outcomes are used to measure cost, benefits, and cost effectiveness for healthcare services. Financial outcome can be evaluated by comparing the outcome from one group of healthcare services with the outcome of another group of healthcare services. It can also be used to compare the financial outcome of healthcare services with requirements from Reference module.

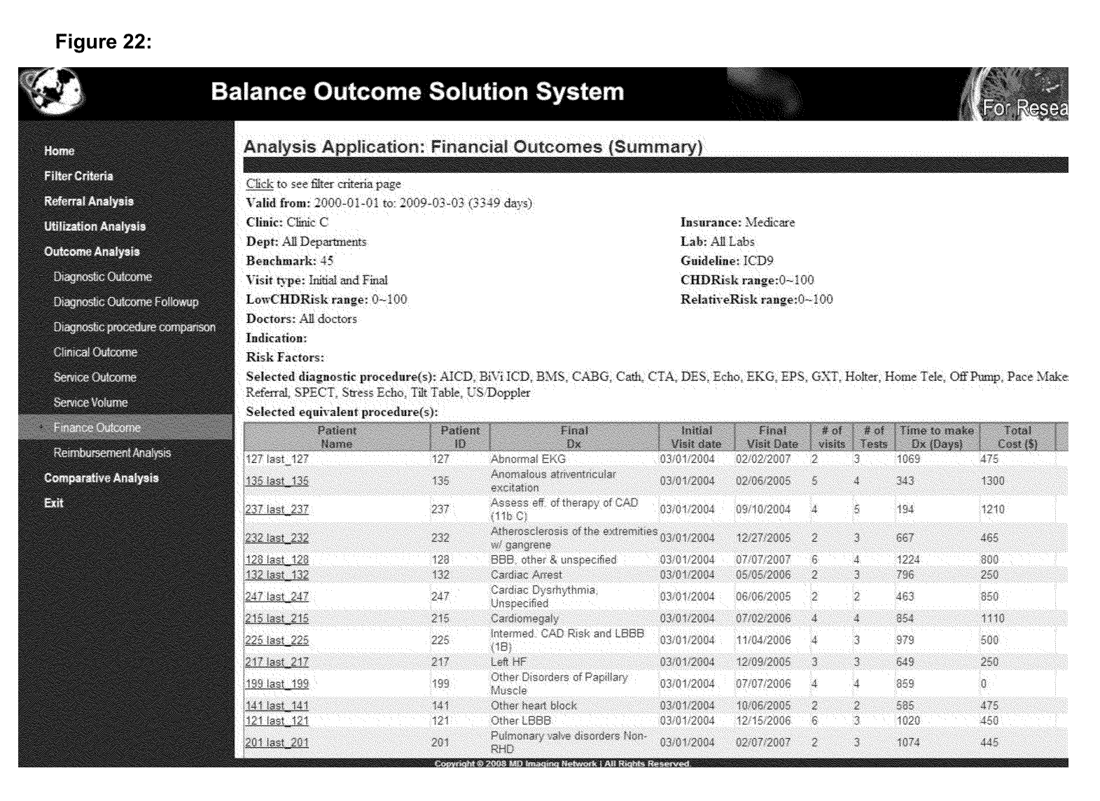

Financial outcomes include reimbursement status, financial benefits and costs. FIG. 22 illustrates an exemplary outcome GUI including a financial outcome report by patient showing, for each patient, the final diagnosis, the initial visit date, the final visit date, the number of visits, the number of tests performed, and the time to make the diagnosis and the total costs.

This system provides web user interface to:
Define tasks such as procedures which related to financial outcomes
Define cost measurements for each task {CM}
Define benefit and resource measurements for each task {BM}
Define how to measure cost effectiveness for each task {CE}
Input guidelines or references for financial outcomes {GL}
Track and analyze Management outcomes

{OC_{fn}}=Function({CM},{BM},{CE},{GL})

### 1.14.2 Tracking

Identify tasks related to Financial outcomes
Measure cost for each tasks {CM}
Measure benefit for the tasks {BM}

### 1.14.3 Analysis

Calculate cost effectiveness for each task {CE}:

CE=ΣBM−ΣCM
Evaluate outcome: compare Financial outcomes

{OC_{fn}}=Function({CM},{BM},{CE},{GL})

A user may define the function for calculating Financial outcomes. In an exemplary embodiment, the Financial outcome is calculated by: {OCₘₜ}=ΣCE, where CE=ΣBM−ΣCM.

### Interactions Among Outcome Module and Other Modules

In this invention with PRO system 100, the patient care process performance is not only improved through Process Module 110, and Reference Module 120 or Outcome Module 130 alone, but also, more importantly, through the interactions among the three modules. It is the Interactions among the 3 Modules that make it an Eco System for further performance improvement. The plurality of functional assessments that define the functional interaction between process module 110, reference module 120 and outcome module 130. Exemplary functional assessments included: Implementation, Validation, Tracking with Tags, Feedback, Comparison, and Customization. A detailed description about those six areas is given in the following sections.

### A. Implementation: The Status a Reference Implementation

The implementation is to use evaluates the interaction between Process Module 110 and Reference Module 120, and further outcome module 130 in, e.g., in the following categories: Implemented, Non-Implemented, Used or Not-Used Reference. An Implemented reference is the reference which has been accepted and implemented through its systems by a healthcare organization, such as a guideline. Otherwise, the reference is a Non-Implemented reference. If a reference is used in a patient care by a provider, this reference is a Used reference, otherwise, it is a Not-Used reference.

The PRO system 100 tracks both the number of guidelines being implemented and the number of guidelines being used:

Implemented References: {RE_{implemented}}={RE_{implemented}_{_{—}}₁, . . . , RE_{implemented}_{_{—}}ₙ₈}⊂{REᵢ}

Used References: {RE_{used}}={RE_{used}_{_{—}}₁, . . . , RE_{used}_{_{—}}ₙ₉}⊂{REᵢ}

The Steps of the Reference Implementation and Use are specified in the following prophetic example:
An organization implements related reference into their healthcare process to reflect the performance of the compliance to the standard care. For example, Hospital One accepted and implemented 8 out of 10 Appropriateness Criteria for Medical Imaging in early 2010 (8 Implemented References and 2 Not-Implemented References in Diagnostic Imaging). This can be further used to compare with other hospitals to rank the compliance of certain references or standards.
In a care process, providers offer specific cares to their patients based on reference (compliance to the standard) or not (not compliance to the standard of care). For example, further evaluating 1,000 patients' use of these References in the 1^{st} quarter of 2010, the data suggested 65% of patients complain these References (35% Not-Used). Reference Implementation and Use reports may indicate: (1) which References should be implemented, but not yet; (2) which References should be used for imaging test selection process, but not yet. These functions can be measures of potential for an organization's improvement. The Guideline Implementation reports can be sent back to healthcare providers or related personnel. In general, Reference module generates recommendations for healthcare providers {HP}, for patients {PT}, for patient visits {PV}, and for specific cares.

Improvement Recommendations: {IR₁}={IR_{HP},IRpt,IPpv,IRsc}
Further, Outcome module analyzes the results from the Process module, compares the recommendation or standard from the Reference module, and generates related Outcome Reports. For example, Clinical Outcome (Outcome) in the Dept of Cardiology often uses the rate of myocardial infarction (MI) as complication to assess the adverse event of a new medication treatment (Process) and compared to the standard treatment (Reference). Other Outcomes, for example, Financial Outcomes (such as costs) can be added to analyze these patients with the new medication treatment compared to the Standard of care.
Based on the information in the outcome reports, an organization may improve their healthcare processes by implementing required References/Standard and use the recommendations of the References/Standard as well as their related Outcomes in the related care process.

New Care Selections: {SC_{new}}=Function({SC},{IR₁})

### B. Applicability

The Applicability analyzes the function of coverage and validation by related references in a patient care process through interactions among Process Module 110, Reference Module 120, and Outcomes Module 130.

The applicability of a reference in a process can be divided into three categories: Fully-covered (100%), Not-covered (0%), and specific % covered between 0 and 100.

Applicability {AP}=({AP_{100%}},{AP_{0%}},{AP_{1-99%}})

The steps of the applicability functional assessment is specified in the following prophetic examples:
In a patient care process, providers apply specific references to their patients based on industrial or organization's requirements. For example, the physicians of Hospital One utilize Appropriateness Criteria for Medical Imaging in the patient care process of test selection.
Applicability assesses how well the Reference covered during a patient care process. For example, diabetic female patients are not covered in the Appropriateness Criteria of SPECT Imaging, therefore, the Applicability is 0%.
The Outcome reports may contain information about misused cares even though the usages meet guidelines. The reports analyze the information and finds out Not-covered Indications or Not-well-covered Indications. Recommendations for updating current healthcare guidelines {GL} can be generated to improve Not-covered or Not-well-covered ones

Improvement Recommendations: {IR₂}={IR_{IN}_{_{—}}_{Uncovered},IR_{IN}_{_{—}}ₙₒₜ_{_{—}}_{well}_{_{—}}_{covered}}
The Outcome reports can be sent back to healthcare providers or other authorized organizations for further management improvement.
Further, Outcome module 130 analyzes the results of Process module 110, compares the recommendations form the Reference module 120, and generates related Outcome Reports. For example, Clinical Outcomes (clinical complications) and Financial Outcomes (such as costs) can be analyzed in these group of not covered patients of diabetic females in the Appropriateness Criteria, indicating their clinical outcome were poor with higher cost.
Based on the information contained in the outcome reports, providers or organization may improve their healthcare processes by updating the Reference stored in the Reference module.

New Guidelines: {GL_{new}}=Function({GL_{existing}},{IR₂})
Healthcare processes are improved by creating new References.

New Care Selections: {SC_{new}}=Function({SC},{GL_{new}})

C. Tracking with Tags:

Tracking with Tag sets is to create a link between Process Module 110 and Outcomes Module 130, through specific tags with its selected sub-processes and steps of the patient care process in Process Module 110. A tag set specifies the requirements for the tagging functions as outlined in the Tag Set section above.

Process module 110 links the Outcome Module 130 with a tag set defined by a user, carrying out the tag requirements to evaluate a selected patient care processes. When a tag is selected, Outcome Module 130 generates an outcome report based on the requirements {TR}. After the report is created, the outcome module 130 automatically transmits the report based on the {TR} designated time. For example, a physician may want to verify his diagnosis through a lab test. He can tag the test using the Tag sets. When the test is finalized, Outcome Module 130 will detect the tag and send the tagged report to the physician immediately (or at certain time, such as 7:30 AM before working, designated by the Physician) and compare with his original diagnosis.

### D. Feedback

As outlined above, the feedback is an action step designated by the users, providing the report of outcomes from Outcome module 130 to the process module 110.

### E. Reference Comparison

Reference Comparison compares different references applicable to the same patient care process. There are many References to assess the performance or regulate a patient care process. For example, to assess eligibility for imaging test reimbursement, ICD9 guideline, Clinical Practice Guidelines, Appropriateness Criteria can all being used. In addition, many professional societies may create their own sets of the references, such as American College of Cardiology (ACC) and American College of Radiology (ACR). Outcome Module 130 analyzes the performances of the Process under different References and generates their respective outcome reports.

Comparison Results: {CR}=Function({SC},{GL},{OC})

The reports may provide important information about which references are suitable for the patient care processes better and which references should be upgraded for better guidance to patient care in a specific population.

The Reference Comparison is described in the following prophetic example:
In a healthcare processes, providers apply specific references to their patients based on different industrial or organization's requirements. For example, the physician Group A utilize ACC (American College of Cardiology) Clinical Practice Guidelines and Group B utilize ACR (American College of Radiology) Clinical Practice Guidelines for Medical Imaging in the patient care process of test selection.
Outcome module 130 compares different patient care process performances and generates its prospective Outcome Reports. For example, Clinical Outcomes (clinical complications) and Financial Outcomes (such as costs) can be analyzed patients used the ACC References vs. ACR References in similar patient population,
The Outcome reports can be sent back to patient care providers or related personnel. Based on the information contained in the outcome reports, the organization may improve its patient care processes by choosing the reference with better outcomes. Authorized people may adjust or select better Reference for implementation in the patient care process in certain patient population for better outcomes.
Patient care processes are improved by better guidelines.

New Care Selections: {SC_{new}}=Function({SC},{GL_{better}})

### F. Customization

Customization is to fit or transform national or regional References in local Practice Specific References. National Clinical Practice Guidelines are healthcare guidelines which apply for the whole country. By evaluating patient care process performance using national Clinical Practice Guidelines, Outcome module 130 indicates that some parts of those guidelines may not be suitable for specific local areas. The outcome reports can suggest that national Clinical Practice Guidelines should be customized into local Practice Specific References for better serving patients in the local areas. Such as, in Indian reservation area, diabetes (DM) is very common. Therefore, certain guidelines not particular to the patients with diabetes may not applied well.

The customization contains the following steps:
In a healthcare process, physicians apply specific care to patients based on information about patients and patient visits. The care selections are based on national Clinical Practice Guidelines.
Outcome module 130 analyzes the outcomes of its reference utilized in this specific patient care process.
The Outcome reports may contain information about misused care even though the cares meets the reference. The reports analyze the information and identify the problems of the reference such as the national Clinical Practice Guidelines. Customization recommendations are generated.

Improvement Recommendations: {IR₃}={IRₙₐₜᵢₒₙₐₗ_{_{—}}_{cpg}}
The Outcome reports may be sent back to the providers or related and/or authorized organizations. Based on the information in the outcome reports, physicians or other authorized people may adjust/revise the national Clinical Practice guidelines, or customized to local Practice Specific Guidelines.

Customized Guidelines: {GL_{customized}}=Function({GLₙₐₜᵢₒₙₐₗ_{_{—}}_{cpg}},{IR₃})
Healthcare processes can be improved by customized guidelines.

New Care Selections: {SC_{new}}=Function({SC},{GL_{customized}})

For example, a particular healthcare guideline suggests that SPECT be used for patients who have acute chest pain for heart attack diagnosis. A new study of the Patient Care Selection indicates that the diagnosis can be improved by using a new technology CTA. Therefore, an outcome report of the Patient Care Selection is generated and forwarded to the Reference Module 120. The outcome report suggests a substitute of SPECT using CTA as diagnosis of choice for acute chest pain. Based on the outcome report, the Reference Module 120 updates the healthcare references incorporating the new finding for patient care recommendation. After that, the updated healthcare references will give better recommendations, CTA rather than SPECT, to the Process Module 110, for a better guidance of the process, assessing patients with acute chest pain.

The New References provides the 2^{nd} mechanism for recommendations to the Process module 110 (1^{st} is Feedback directly from Outcome Module 130 to Process Module 110) through Changing its Reference Module 120 to the regulated Process. This step is not as fast as the 1^{st} one, but can serve as a long term Recommendation with wider coverage area.

It consists of the following steps:
New findings of a care process (Process module 110) are created in Outcome module 130 as Outcome Reports, providing recommendations for the guidelines.

Improvement Recommendations: {IR₄}={IR_{new}_{_{—}}_{finding}}
The Outcome reports can be sent back to authorized organizations as national Clinical Practice References and local Practice Specific Reference.
Based on the information in the outcome reports, authorized personnel may update the national references and/or local Practice Specific References.

Customized Guidelines: {GL_{new}}=Function({GL_{existing}},{IR₄})
Patient care process performance is measured and the new Reference can be used for improvement:

New Care Selections: {SC_{new}}=Function({SC},{GL_{new}})

### Patient Care Selection Using the PRO System

This Section is to use an example of assessing coronary artery disease (CAD) in patients (Pts) with Diabetes (DM) to illustrate how to use all 3 modules of the PRO system and their interactions to improve the performance of a patient care selection process

### A. PROCESS Module

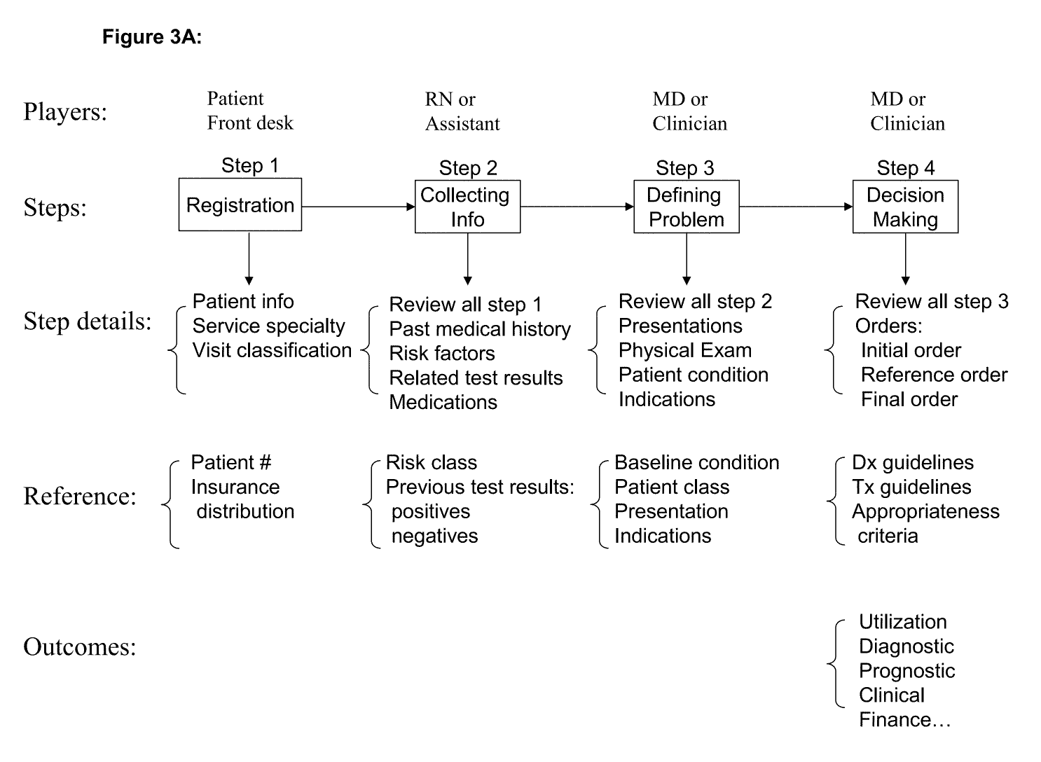

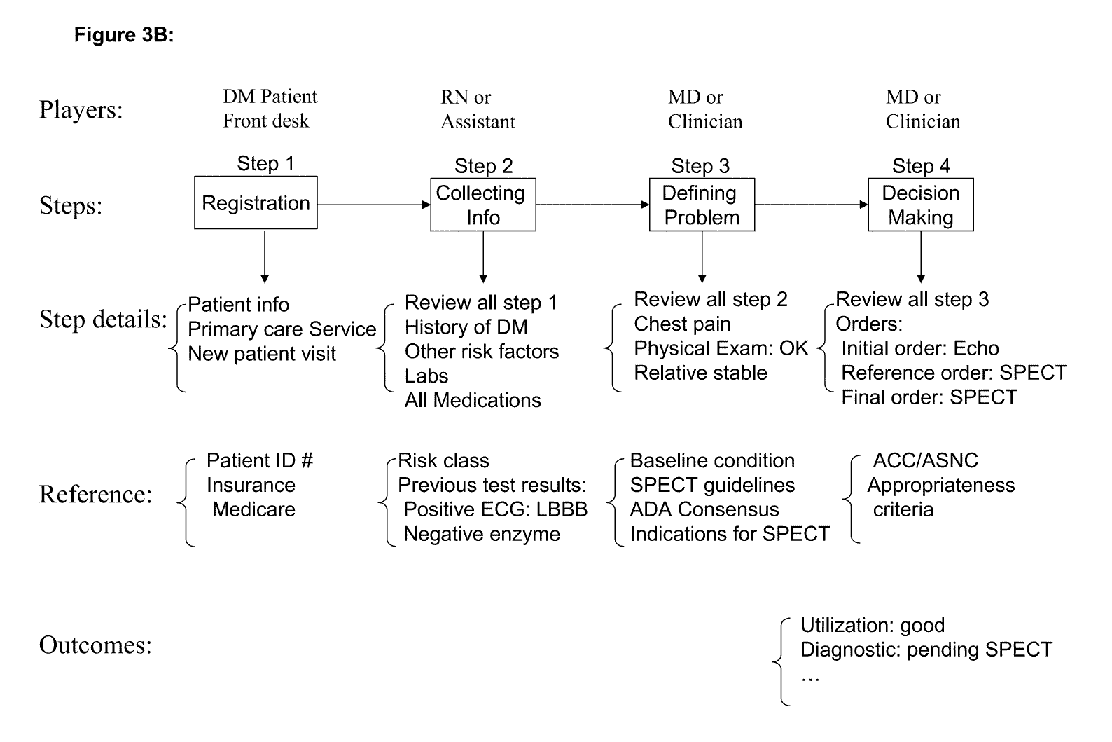

Process module 110 in the management system 100 for A Patient Care Process includes 4 steps (see FIG. 3): Registration, Collecting Info, Defining Problem and Decision-making. FIG. 3A illustrates each specific steps of the Patient Care Process to assess CAD in a diabetic patient with chest pain and abnormal ECG.

A patient's past history includes the patient's past medical history, family history, genetic history and any past procedures that the patient may have undergone. The patient's past history may be used to characterize the patient such as a Diabetes patient (DM) or a Coronary Artery Disease patient (CAD). Patient presentations include symptoms or signs of a condition such as chest pain. Patient risk factors such as diabetes or hypertension are typically identified when a patient visits a healthcare provider. Many risks can be grouped with an established model, such as a Framingham Score, which classifies the patients as low, intermediate or high risk. Indications are the summaries of the reasoning for patient care selection. When a diabetic patient visits a primary care MD, the indications of chest pain and abnormal ECG need to be provided in order to determine whether a SPECT test selection and reimbursement are appropriate for this procedure. The data items during the patient care process may be extracted directly by Process module 110 or by a data extraction tool and fed to Process module 110. After the information is collected, it will be stored in the database for further analysis in conjunction with Reference and Outcome Modules.

This example can also be used for an organization such as a clinic to assess its organizational performance on its DM management. For example, to assess the performance of CAD diagnosis in DM patient in its Dept of Family Medicine, a 10 physician group's performance in this Clinic, one can create the Process into 3 steps: (1). Patient Selection: patients (2,000 patients) with diagnosis of DM (1,000 DM patients); (2). Test Selection: select test of calcium scoring (CS) using CT appropriately (600 patients used CS tests); and (3). Decision-making for clinical management: the patients with the use of CS and positive (300 patients) then treated using aggressive regimen (LDL, blood pressure and glucose/Hba1c control level, etc) compared with the patients without CS tests (400 patients) and not knowing what the cardiac status and not aggressive treatment. The performance of the process between Step 1 and 2 is 600/1000, 60%. This automated and real time Process Performance can be displayed for all 10 physician as a group for the Dept performance, as well as in individual physicians to see the difference among the 10 physicians in the Dept. The real time display may significantly improve individual physicians and then the group's performance using the process performance index.

### B. Reference Module

The Reference Module 120 (often as guideline or standard care) of the patient care process is usually used to judge the correctness or appropriateness of the healthcare selection. In the case of test selection to assess the DM patient with chest pain and abnormal ECG with LBBB (Left bundle branch block), recommendations of SPECT imaging from American College of Cardiology/American Society of Nuclear Cardiology (ACC/ASNC) Appropriateness Criteria or American Diabetic Association (ADA) Consensus can be used for the test selection. If a doctor selects a test, in this case, SPECT imaging, which matches the references, the test service will be appropriately used. If a doctor selects a service but the references do not recommend the service, the service is over-used. If a doctor does not select a service but the references recommend the service, the service is under-used.

Automated and real time assessment of the Family Medicine Dept as above is used the national guidelines from professional society can display the utilization of Appropriate use (600/1000, 60%), Under-Use (1000−600/1000, 40%) and Over-use (assuming 100 CS tests in the other 1000 patients which are not indicated, then, 100/1000, 10%). This live and automated display for the Dept physicians and the Clinic may also significantly decrease test overutilization in.

### C. Outcome Module

See FIGS. 10-3A, 10-3B, 10-4A and 10-4B which illustrate all 15 examples to assess variety outcomes related with coronary artery disease (CAD) in patients with DM, such as Diagnostic Outcome, Treatment Outcome, etc. It is self explanatory using the specific examples of a particular outcome in comparison with its outcome in Table 10-3A, 10-3B, 10-4A and 10-4B. Using the above diabetes example, if the patient SPECT was positive with a large size ischemia, then, the subsequent catheterization showed severe stenosis (95%) of proximal LAD and the patient underwent stent. The Diagnostic Outcome for SPECT was excellent since the results of the SPECT is consistent with the gold standard catheterization. The patient ECG is normalized post-stent and chest pain was resolved after the procedure. Therefore, the Treatment Outcome is good as well.

Using the above Family Medicine Dept example, one can assess Clinical Outcomes of MI (heart attach) in patients who had CS tests and were aggressively managed compared with the patients who did not have CS test and were not aggressively managed to see the benefits of the CS tests. Financial Outcomes also can be assessed to see the cost of saving a MI. Other Outcomes can also be automated and real time assessed in these patient population: such as, CS Diagnostic Outcome in accuracy of total atherosclerosis burden using CS (only can assess calcified atherosclerosis) to compare with CTA (assess both calcified and non-calcified, soft, atherosclerosis); CS Treatment Outcomes in CAD treatment effectiveness, patients diagnosed with CS over 400 are aggressively treated for CAD compared with the patients without aggressive treatments; Prevention Outcome in prevent of ischemia, patients with mild CS 100 aggressively using exercise and diet compared with patients without aggressive exercise and diet; Utilization Outcome in using the CS test as above Appropriate, Over and Under-utilization rate compared to the Guidelines; Prognostic Outcomes in prediction of MI in patients used CS vs. patients without CS; Satisfaction Outcome in patients with CS and change life styles vs. patients without CS; Service Outcomes in service volume in terms of subsequent tests (such as SPECT or CTA) and treatments in patients that used CS vs. without CS test; Workflow Outcome in efficiency to use CS test though the Dept Process; Information Flow Outcome in Accuracy of physicians used the guidelines in CS tests; Communication Outcome in understanding the CS test results and implemented in their patients' care management (subsequent appropriate tests and medical treatments); Management Outcome in the service volume expansion with the automated and real time display to the physicians and Dept; Referral Outcome in number of DM patients referred to CS test; Service Truthfulness Outcome in patients claims submitted to reflect the tests performed, not including patients without CS tests, etc. Other new outcomes can also be created, such as new medication recovery Outcome in patients' data collected and anonymously sent to pharmaceutical companies to identify more specific patients for further new inventions or testing with other new medications.

### D. Interactions Between the PRO Modules

The outcomes verify and improve the performance of the process directly through feedback of specific results of the process from a variety service aspects (diagnosis, clinical, finance, etc) and also through indirect reference through compliance with the Standards. With advances of technology and clinical care, the reference (guidelines and standard) usually are updated and revised further based on the Outcomes of the care selection. For example, ECG stress test was served as a standard of care to diagnose patients with coronary artery disease in 1970s. With technology improvement, stress echocardiography, stress SPECT imaging in 1990s and coronary CTA in later 2000 have become the standard care based on the diagnostic outcomes where these 3 imaging techniques have superior accuracy compared to the stress ECG in the early 70s. Therefore, the outcome module can change the patient care selection process through the references to improve the patient care service performance.

### Live Board for Real-Time Outcome Monitoring

As illustrated at beginning and throughout the invention, one of the key functions is to provide Real-Time and Automated report on Outcomes using the PRO structures along with data extractions (described elsewhere) hardware and database systems described under the Section of Hardware/Software System Overview.

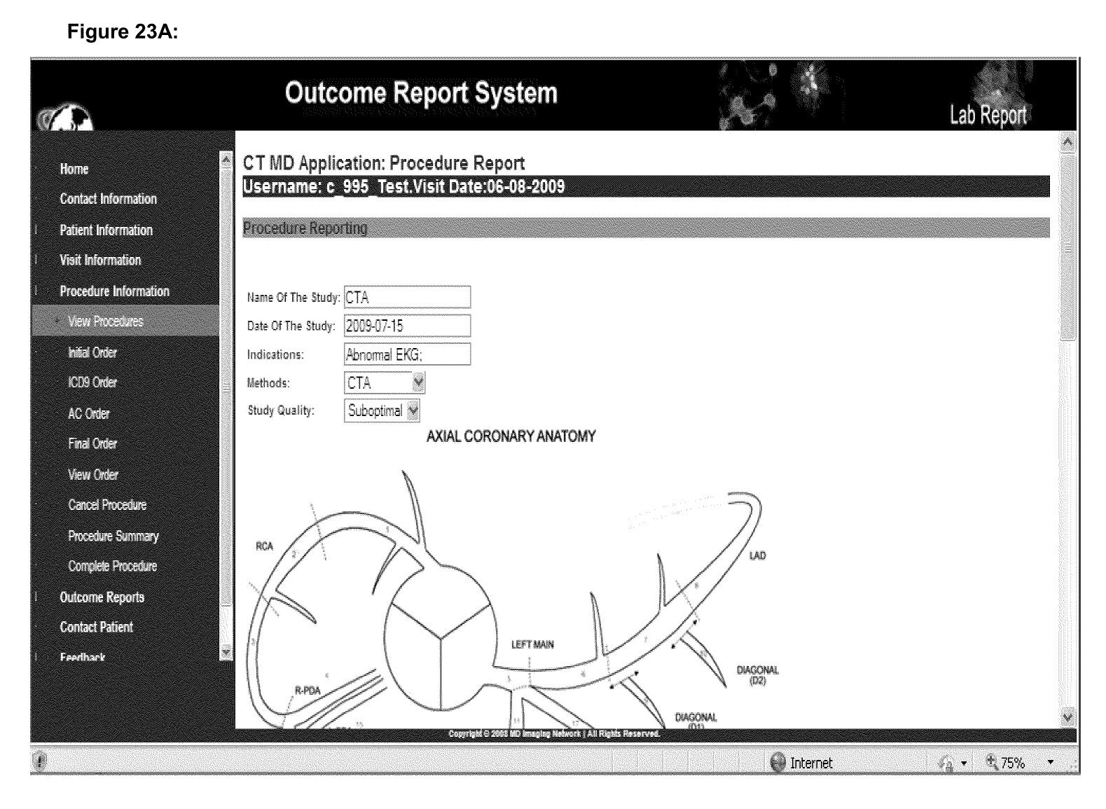

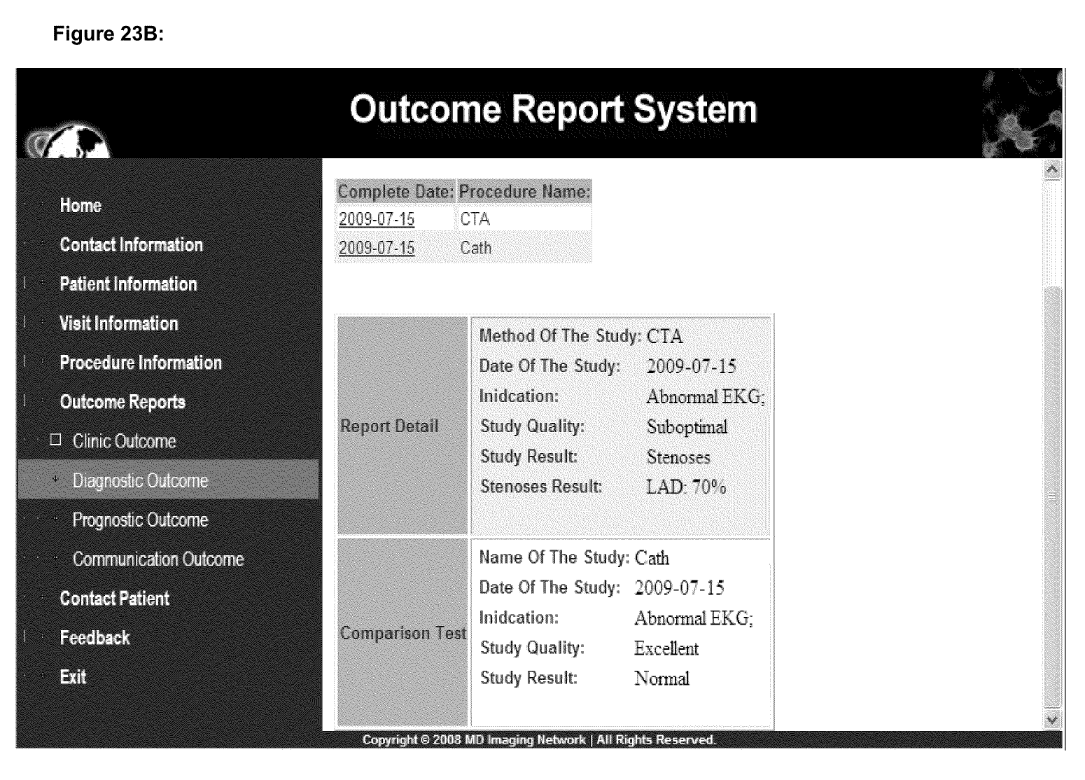

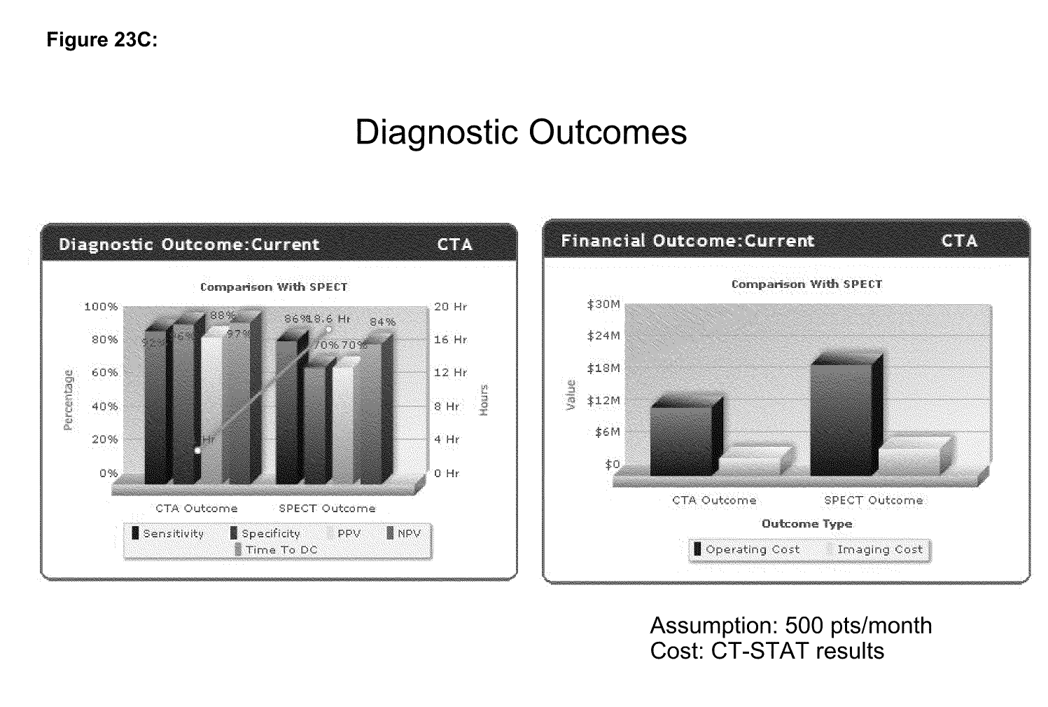

For example, FIG. 23A-C illustrated the Report on Diagnostic Outcome of CTA in diagnosis of coronary disease and comparison with other imaging modalities. Using the Diagnostic Outcome described in Paragraph 1.1[0057-0058]. A user may analyze CTA Diagnostic outcomes form an individual patient to a group. The user is prompted to choose the testing procedure as Cardiac CTA. The outcome module 130 calculates the Accuracy as the one of Diagnostic Outcomes using sensitivity, specificity, positive predictive value and negative predictive value.

This system provides web user interface to:
Define problems {P}
   What: Cardiac CTA
   When: After completion of CT and comparative standard, Cath
   Where: CT Imaging Lab
   Who: MD interpreting cardiac CTA, such as a radiologist or a cardiologist
Define possible diagnosis {D} for coronary disease as a Problem
Input guideline or reference for diagnosis {GS} as Cardiac CTA guidelines defined by a professional organization, provider or payer
Track and analyze Diagnostic outcomes

{OC_{jd}}=Function({P},{D}, . . .
Identify a group of patients with chest pain and possible coronary diseases as Problems {P′}<{P}
Collect a group of diagnostics {D} of patients with CTA diagnosed disease as Problem {P}
Collect the diagnosis using standard procedure: {GS}, catheterization
Collect the real findings {F} about the diagnosis: {F} from cath or other methods, such as surgery or pathology
Calculate Diagnostic accuracy: compare the diagnostics {D} with standard diagnosis {GS} or with real findings {F} from cath
Evaluate outcome: how many items in {D} match with {F} using the formula of sensitivity, specificity, positive predictive value and negative predictive value

{OC_{jd}}=Function({P},{D},{GS},{F})

After setting up the CTA Diagnostic Outcome, as soon as a patient completes his coronary CTA, his report (FIG. 23A) is entered the PRO System. The non-invasive CTA is reported as 70% of stenosis on LAD (left anterior descending artery), although the imaging quality was suboptimal. Right after the Gold Standard, Cath, is performed later of the day on the same patient, the cath results will be sent to the Diagnostic Outcome Report immediately in real-time, through the above designated tag system in Diagnostic Outcome mentioned above in the PRO system. However, the invasive Cath reveal a normal coronary (FIG. 23B). Therefore, the Diagnostic Outcome of CTA on this patient is poor, being false positive. After pull out a group of patients' data together with calculated CTA diagnostic testing accuracy outcomes in this group using the PRO System, one can easily see that the feedback from the Real-time and Automated feedback features—the Diagnostic Outcome report can significantly help the healthcare providers (such as the radiologist doing the CTA reporting, their administration Q/A or research) in quality control and improvement to identify the causes of poor CTA results in these patients. In addition, this feature can also be utilized for waste and fraud control, in case some outliers of providers' Diagnostic Outcomes are consistently lower than the norm. Further more, certain delay may also be setup to fit in a specific physician's schedule, depending on the user setup. For example, Dr Jones may setup the feedback to his office time for Q/A at 10:00 AM on Wednesdays.

As illustrated earlier of this invention, any outcomes can be used together to answer real world questions based on the user selection. For example, as shown on FIG. 23C, the Diagnostic Outcomes of CTA (Sensitivity, Specificity, Positive and Negative Predicted Values as well as Discharge Time) are compared with the Diagnostic Outcomes of SPECT in managing patients with acute chest pains in the emergency room. Clearly, the Diagnostic Outcomes of CTA is better than SPECT in this patient population, especially in the Discharge time, decreased from 18 hrs to 3 hrs (see the left side FIG. 23C). When these Outcome results applied to clinical service for a hospital with 500 patients per month, the cost savings of Financial Outcomes can be over $20 million due to much lower costs in Operation and Imaging. It's better (Diagnostic Outcomes), Faster (Discharge Time) and Cheaper (Cost).

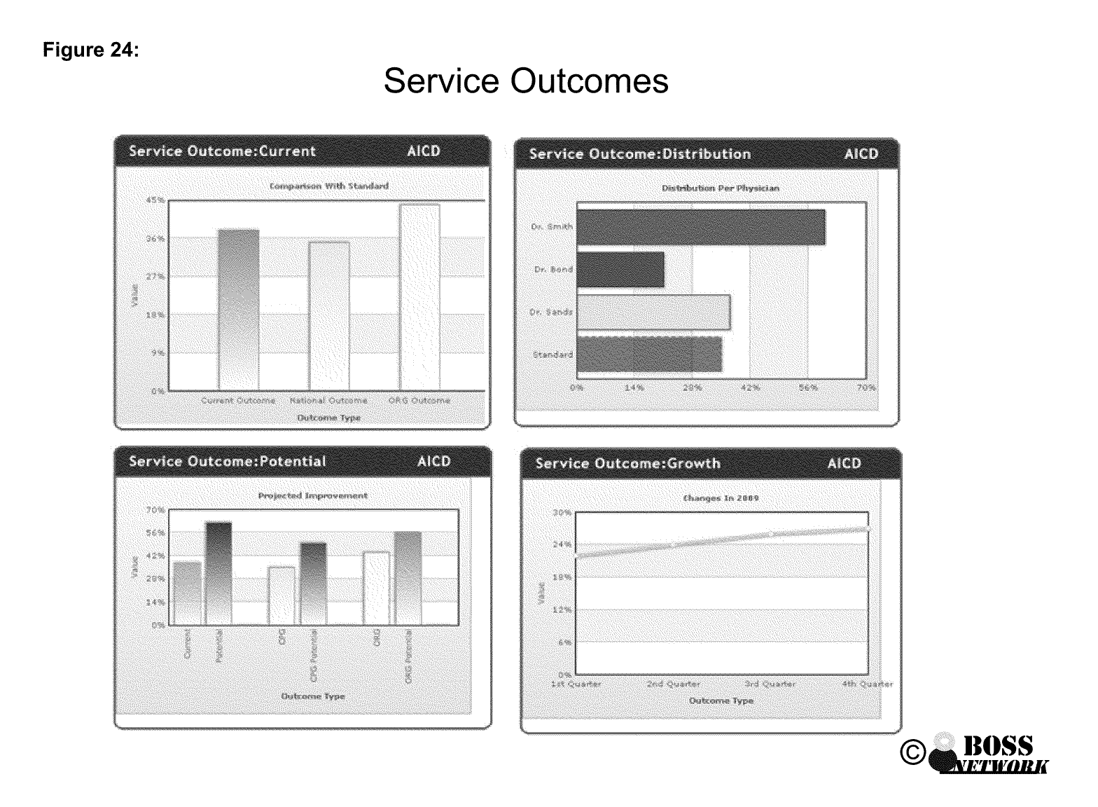

FIG. 24 illustrated the Service Outcomes on AICD utilization. Top left shows the current service, although is higher than the national average, is still bellow the organizational goals. Top right shows the quarter trend over a selected time period. The bottom left shows the potentials still significant in identify the patients who needed AICD but not received yet. The bottom right shows the details where the potential improvement can be optimized in terms of how individual physician's utilization. Clearly, Dr Bond needs further improvement in AICD utilizations compared to his colleagues, national levels and organizational goals. Integrating variety of outcome analysis, providing automated and real time analysis can significantly improve the performance of healthcare.

In summary, using this PRO System, data collected from certain healthcare service of organization (a clinic or hospital, even a healthcare network at regional, state, national or even international level) can be fed into the Process module, to layout digital mapping of the service. Then, it is regulated by the Reference module and finally assessed and feed backed by Outcome module. The interactions of these 3 modules at a variety of aspects of the service (diagnosis, treatment, clinical, management, finance . . . ) can build a functional eco system for service self improvement to continuously shaping its performance.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, elements, and/or components, but do not preclude the presence or addition of at least one other feature, element, component, and/or groups thereof.

The corresponding structures, materials, acts and equivalents of all means plus function elements in the claims below are intended to include any structure, or material for performing the function in combination with other claimed elements as specifically claimed. The description of the present invention has been presented for purposes of illustration and description, but is not intended to be exhaustive or limited to the invention in the form disclosed. Modifications and variations will be apparent to those of ordinary skill in the art without departing from the scope and spirit of the invention. The embodiments described were chosen and described in order to bests explain the principles of the invention and the practical application, and to enable others of ordinary skill in the art to understand the invention for various embodiments with various modifications as are suited to the particular use contemplated.

1. An automated and real time healthcare performance improvement system for patient care processes, where a patient care process includes a plurality of sub-processes and each sub-process includes a plurality of steps, said system comprising:
a first computer that receives patient care process data from one of a service provider, a payor, and a patient;
a process module operating on a server in communication with said first computer that (1) generates a model of the patient care process, (2) maps said plurality of sub-processes and said plurality of steps to the patient care process, (3) receives data generated in the patient care process, (4) stores that data in accordance with the map and model, links the data to reference and outcome modules;
a reference module that receives references and extracts and converts the references to computer usable format;
an outcome module connected to said process module and said reference module, said outcome module identifies a specific outcome for analysis based on user input, receive patient care process data corresponding to the specific outcome, analyzes patient care process data based on a user defined model/calculation and generates outcome data indicative of performance of the patient care process.

2. The system of claim 1 wherein said outcome module tags a target destination for the performance indicator, tracks the tagged performance indicator.

3. The system of claim 2 wherein said outcome module includes means for transmission of the performance indicator.

4. The system of claim 2 wherein said outcome module includes a transmission schedule for the performance indicator.

5. The system of claim 1 wherein said outcome module receives specific reference data and compares the reference data to patient care process data and generates a parameter that indicates performance of the reference.

6. The system of claim 1 wherein said outcome module compares outcome data to reference data and generates a performance indicator for the reference.

7. The system of claim 1 wherein said outcome module includes at least one of Diagnostic outcomes, Treatment Outcomes, Prevention Outcome, Utilization Outcomes, Predictive or Prognostic Outcome, Satisfaction Outcomes, Clinic Outcomes, Service Outcomes, Workflow Outcomes, Information Flow Outcomes, Communication Outcomes, Management Outcomes, Referral Outcome, Service Truthfulness Outcome and Financial Outcomes.

8. The system of claim 1 wherein said outcome module generates an outcome report including outcome data, said report being generated in a combination of one or more of the following formats: text, voice, image, and video.

9. The system of claim 1 wherein said outcome module continuously tracks one or more outcomes and notifies a user if the tracked outcome exhibits a predefined characteristic.

10. The system of claim 5 wherein the outcome module generates a parameter indicating applicability of the reference to the patient care process.

11. The system of claim 1 wherein said outcome module receives first and second references corresponding to the patient care process and generates a performance indicator for each reference.

12. The system of claim 1 wherein said outcome module generates at least one of Diagnostic Outcomes, Treatment Outcomes, Prevention Outcome, Utilization Outcomes, Predictive or Prognostic Outcome, Satisfaction/Mentality Outcomes, Clinic Outcomes, Service Outcomes, Workflow Outcomes, Information Flow Outcomes, Communication Outcomes, Management Outcomes, Referral Outcome, Service Truthfulness Outcome and Financial Outcomes

13. The system of claim 5 wherein the outcome module includes a Diagnostic Outcomes module that (i) collects data from a designated diagnostic test/procedure performed on a patient, (ii) collects data from a designated standard test/procedure performed on the patient, (iii) compares results of the designated diagnostic test/procedure to results of the designated standard test/procedure to assess the accuracy of the designated test/procedure.

14. The system of claim 5 wherein the outcome module includes a Treatment Outcomes module that measures correctness of treatments for given problems, compared with the differences between actual results and the intended goals.

15. The system of claim 5 wherein the outcome module includes a Prevention Outcomes module that measures effectiveness of prevention for given problems or diseases.

16. The system of claim 5 wherein the outcome module includes a Utilization Outcomes module that compares the actual utilization of sub-processes and steps in the patient care process with recommendations from said reference module.

17. The system of claim 5 wherein the outcome module includes a Prognostic Outcome module that predicts future outcomes based on current available data and models.

18. The system of claim 5 wherein the outcome module includes a Satisfaction Outcomes module that measures a patient's happiness and satisfaction to the service they received.

19. The system of claim 5 wherein the outcome module includes a Clinic outcomes module that generates at least one of complications, morbidity, mortality, longevity and quality of life.

20. The system of claim 5 wherein the outcome module includes a service outcomes module that measures service efficiency between one service provider and another.

21. The system of claim 5 wherein the outcome module includes a Workflow Outcomes module that measures the effectiveness or efficiency of workflow processes in healthcare services.

22. The system of claim 5 wherein the outcome module includes a Information Flow Outcomes module that evaluates performance of information processes for healthcare services.

23. The system of claim 5 wherein the outcome module includes a Communication Outcomes module that measures the speed and accuracy of communication in a care process.

24. The system of claim 5 wherein the outcome module includes a Management Outcomes module that evaluates effectiveness and efficiency of a management in healthcare.

25. The system of claim 5 wherein the outcome module includes a Referral Outcomes module that measures referral results for given procedures or providers.

26. The system of claim 5 wherein the outcome module includes a Service Truthfulness Outcomes module that measures service truthfully performed or fraud, waste abuse for given procedure, patients, physicians or healthcare institutions.

27. The system of claim 5 wherein the outcome module includes a Financial Outcomes module that measures costs and benefits for healthcare services.
